(19) United States
(12) Patent Application Publication
(10) Pub. No.: US 2021/0327431 A1
(43) Pub. Date: Oct. 21, 2021

(54) 'LIVENESS' DETECTION SYSTEM

(71) Applicant: LIOPA LTD., Belfast (GB)

(72) Inventors: Darryl STEWART, Belfast (GB); Alexandra COWAN, Belfast (GB); Adrian PASS, Belfast (GB); Fabian CAMPBELL-WEST, Belfast (GB); Helen BEAR, Belfast (GB)

(21) Appl. No.: 17/272,535

(22) PCT Filed: Aug. 30, 2019
(86) PCT No.: PCT/GB2019/052418

§ 371 Date: Mar. 1, 2021

(30) Foreign Application Priority Data
Aug. 30, 2018 (GB) 1814121.8

(51) Int. Cl. G10L 15/25; G06K 9/00; G06K 9/62; G06K 9/20

(52) U.S. Cl. CPC G10L 15/25; G06K 9/00335; G06K 9/2018; G06K 9/00718; G06K 9/6257

(57) ABSTRACT

A detection system assesses whether a person viewed by a computer-based system is a live person or not. The system has an interface configured to receive a video stream; a word, letter, character or digit generator subsystem configured to generate and output one or more words, letters, characters or digits to an end-user; and a computer vision subsystem. The computer vision subsystem is configured to analyse the video stream received, and to determine, using a lip reading or viseme processing subsystem, if the end-user has spoken or mimed the or each word, letter, character or digit, and to output a confidence score that the end-user is a “live” person or not.

### BACKGROUND OF THE INVENTION

### 1. Field of the Invention

The field of the invention relates to lip reading systems, and in one implementation, to a liveness' detection system.

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### 2. Background

The Human Computer Interface (HCI) has evolved over the last 4 decades through command line interface, GUI, mouse, to touch/camera interaction on mobile devices. The launch of Apple's Siri system in 2011 heralded the dawn of the ‘voice-first’ user interface. The use of voice as a primary means of HCI is projected to grow exponentially over the next few years. The advantages to the consumer are obvious. The voice UI is much faster—humans can speak 150 words per minute and in comparison can type 40 words per minute. In addition the voice UI is much easier to use—convenient, hands-free & instant.

Market projections for the voice UI are, however, always caveated by the need to improve accuracy in real-world (i.e. noisy) environments. Speech recognition technologies are all audio-based and, despite advances in noise cancellation techniques, word accuracy rates continue to decline markedly when background noise levels rise. In-vehicle voice activation is continually listed as the ‘most annoying car tech’ in driver surveys, due to poor accuracy in normal driving conditions.

In the race for dominance in the personal assistant market, a number of large players are investing very heavily into improving the accuracy of their solutions, either directly or indirectly via Audio Speech Recognition (ASR) technology partners.

Audio speech recognition word accuracy levels universally degrade in noisy environments. Visual Speech Recognition (VSR) techniques may therefore be used as a supporting technology to audio speech recognition systems. For example, lip reading techniques may determine speech by analysing the movement of a user's lips as they speak into a camera. These lip movements are known as visemes and are the visual equivalent of a phoneme or unit of sound in spoken language. A viseme can be used to describe a particular sound.

Because Visual Speech Recognition (VSR) techniques are not sensitive to acoustic conditions, e.g. background noise or to other people speaking, VSR only systems may also be used in real world environments such as those with large ambient noise.

An example application of a VSR technique is improving the accuracy of voice base virtual personal assistants when using them on smart phones in a noisy environment (e.g. car, public transport, café etc.). A second example includes checking liveness during biometric identification to prevent spoofing using a video or static photograph of a person (a.k.a. ‘replay attack’).

However, implementing VSR techniques in real-world use case scenarios is still a difficult task, where challenges such as the variation in illumination conditions, poor image resolution and speaker head movement may cause some difficulties.

The present invention addresses the above vulnerabilities and also other problems not described above.

### SUMMARY OF THE INVENTION

A first aspect is a liveness detector: it is a detection system for assessing whether a person viewed by a computer-based system is a live person or not, the system comprising:
(i) an interface configured to receive a video stream;
(ii) a word, letter, character or digit generator subsystem configured to generate and output one or more words, letters, characters or digits to an end-user;
(iii) a computer vision subsystem configured to analyse the video stream received, and to determine, using a lip reading or viseme processing subsystem, if the end-user has spoken or mimed the or each word, letter, character or digit, and to output a confidence score that the end-user is a “live” person or not.

A second aspect is an authentication system: it is an authentication system for assessing whether a person viewed by a computer-based system is authenticated or not, the system comprising:
(i) an interface configured to receive a video stream;
(ii) a word, letter, character or digit generator subsystem configured to generate and output one or more words, letters, characters or digits to an end-user;
(iii) a computer vision subsystem configured to (a) analyse the video stream received, and to (b) determine, using a lip reading or viseme processing subsystem, if the end-user has spoken or mimed the or each word, letter, character or digit, and to (c) compare the data from the lip reading or viseme processing subsystem with stored data corresponding to the identify claimed by that person; and to (d) output a confidence score that the end-user is the person they claim to be.

A third aspect is an improved computer-vision based lip reading system: it is a lip reading system comprising:
(i) an interface configured to receive a video stream; and
(ii) a computer vision subsystem configured to analyse the video stream received, using a lip reading or viseme processing subsystem, and to track and extract the movement of an end-user lip, and to recognize a word or sentence based on the lip movement,
   in which the lip reading processing subsystem implements an automatic illumination compensation algorithm.

A fourth aspect is a lip reading system that determines rate of speech: it is a Lip reading system for detecting rate of speech comprising:
(i) an interface configured to receive a video stream, and
(ii) a computer vision subsystem configured to analyse the video stream received, using a lip reading or viseme processing subsystem, and to track and extract the movement of an end-user lip,
   in which the system outputs the end-user rate of speech based on the analysis of the end-user lip movement.

A fifth aspect is a lip reading system that adapts to any pose variation: it is lip reading system comprising:
(i) an interface configured to receive a video stream, and
(ii) a computer vision subsystem configured to analyse the video stream received, using a lip reading or viseme processing subsystem and to track and extract the movement of an end-user lip, and to recognize a word or sentence based on the lip movement,
   in which the lip reading processing subsystem is further configured to dynamically adapt to any variation in head rotation or movement of the end-user.

A sixth aspect is a computer-vision based lip reading system that is resistant to false videos: it is a lip reading system comprising
(i) an interface configured to receive a video stream, and
(ii) a computer vision subsystem configured to analyse the video stream received, using a lip reading or viseme processing subsystem, and to track and extract the movement of an end-user lip, and to recognize a word or sentence based on the lip movement,
   in which the computer vision system is able to detect video splicing attacks using a splicing detection method from the analysis of pixel information across sequential video frames.

A seventh aspect is a computer-vision based lip reading system specifically designed for a voice impaired end-user: it is an automatic lip reading system for a voice impaired end-user comprising:

(i) an interface configured to receive a video stream;

(ii) a computer vision subsystem configured to analyse the video stream received, using a lip reading or viseme processing subsystem, to track and extract the movement of an end-user lip, and to recognize a word or sentence based on the lip movement,

(iii) a software application running on a connected device, configured to receive the recognized word or sentence from the computer vision subsystem and to automatically display the recognized word or sentence.

A eighth aspect is a lip reading system integrated with an audio speech recognition system: it is an audio visual speech recognition system comprising:
(i) an interface configured to receive a video stream and an audio stream,
(ii) a speech recognition subsystem configured to analyse the audio stream, detect speech from an end-user, and recognise a word or sentence spoken by the end-user,
(iii) a computer vision subsystem configured to analyse the video stream received, using a lip reading or viseme processing subsystem, and to track and extract the movement of the end-user lip, and to recognise a word or sentence based on the lip movement,
(iv) a merging subsystem configured to analyse the recognized words or sentences by the speech recognition subsystem and lip reading processing subsystem and to output a list of candidate words or sentences, each associated with a confidence score or rank referring to a likelihood or probability that the candidate word or sentence has been spoken by the end-user.

### BRIEF DESCRIPTION OF THE FIGURES

Aspects of the invention will now be described, by way of example(s), with reference to the following Figures, which each show features of the invention:

FIG. 1 is a high level block diagram of the platform.

FIG. 2 is a high level sequence diagram showing the interactions between an end-user, an application running on a mobile device and the LipSecure cloud service.

FIG. 3 shows block diagrams of the training pipeline and testing pipelines.

FIG. 4 shows a detailed block diagram of the training phase.

FIG. 5 shows a detailed block diagram of the training phase.

FIG. 6 shows a detailed block diagram of the testing phase.

FIG. 7 shows a block diagram with the steps performed in a specific feature extraction use case.

FIG. 8 shows a diagram illustrating an automated data generation system.

FIG. 9 shows a diagram illustrating the feature extraction process.

FIG. 10 shows the architecture of the DNN.

FIG. 11 shows a table of results.

FIG. 12 shows a graph displaying experimental results.

FIG. 13 shows a graph displaying experimental results.

FIG. 14 shows a graph displaying experimental results.

FIG. 15 shows a graph displaying experimental results.

### DETAILED DESCRIPTION

We organized this Detailed Description as follows.

Section 1 is a high level overview.

Section 2 is a more detailed description of how the Liopa system works.

Section 3 is a more detailed description of an Audio-Visual Speech Recognition system.

Appendix 1 is a paper (McShane, Philip, and Darryl Stewart. “Challenge based visual speech recognition using deep learning.” In Internet Technology and Secured Transactions (ICITST), 2017 12th International Conference for, pp. 405-410. IEEE, 2017).

Appendix 2 is a summary of the high level key features implemented in the Liopa system.

### Section 1. Overview

Speech can be determined by analysing the movement of a user's lips as they speak or mime into a camera. These lip movements are known as visemes and are the visual equivalent of a phoneme or unit of sound in spoken language. An example of an application is liveness checking during on-line authentication and is called LipSecure (see Section 2).

However, the technology used in this application is not limited to this use-case. Visual speech recognition techniques may also be combined with audio speech recognition techniques to improve word recognition accuracy across a broad range of environmental conditions (see Section 2 and 3).

Further applications include, but are not limited to:
Improving audio speech recognition systems for example:
   In-vehicle voice activation and control;
   Personal assistants (e.g. Siri, Cortana, Google Now, Echo);
   SmartHome voice control.
Autonomous Visual-only Speech Recognition for example:
   Keyword/phrase recognition in video segment (e.g. surveillance);
   Improved subtitling for live broadcast
   Communicating with people who have impaired vocal cords.

LipSecure requires no additional hardware and works on any device with a standard forward facing camera (e.g. smartphone, tablet, laptop, desktop, in-vehicle dashboard etc.). LipSecure may be used with any standard RGB cameras as well as IR/ToF sensors.

For example, facial recognition, now an established biometric authenticator with multiple applications across many device types, is subject to repeated, high profile spoofing attacks using static images of the subject. By using the LipSecure technology in conjunction with facial recognition, the user will be prompted to speak/mime a sequence of words, letters, characters or digits into the camera, as part of the authentication process, thus ensuring a ‘live’ person is present and the authentication is valid. LipSecure generates and/or displays of the sequence of words, letters, characters or digits on a screen, or provides an audio output via a speaker, and then compares the visemes derived from the video stream captured by the camera with its record of the words, letters, characters or digits; if there is a sufficient match, then it is highly likely that the biometric authentication system is not being spoofed, e.g. with a static photograph. The sequence of words, letters, characters or digits can be randomly selected, or selected from a large corpus, so that spoofing by pre-recording videos of a large number of different words, letters, characters or digits is extremely difficult. The system can be configured to ask questions, such as ‘what colour hair do you have?’ and to compare the answer (e.g. ‘brown’) using both the visemes for the word ‘brown’, the speech recognition engine analyzing the speech as the word ‘brown’, and a computer vision system analyzing the portion of the user's head that contains hair and determining its colour. Therefore we have a multi-factorial approach to securing biometric authentication.

Further potential use cases include, but are not limited to, the following:
Legal/security:
   Non-repudiation of on line transactions;
   Anti spoofing during on line authentication;
Surveillance:
   Detection of “words of interest”, key words/phrases in CCTV footage;
Social media:
   Securing Identity confirmation during social media interactions;
Detecting consumption of drugs or alcohol:
   Prevention of driving/use of machinery while under the influence of drugs or alcohol;
Robotics/Intelligent Manufacturing:
   Interaction with machines in industrial environments;
Emotion/Behavioural detection:
   Anger Detection/Alerts in public environments or during on line transactions;
   Detection/Alerts when subject is tired;
Assisted Living:
   Real time subtitling of media;
   Assisting hear impaired with conversations (e.g. google glasses app which gives real time transcription of speech from whomever the glasses are pointed at);
Speech to Speech:
   Recreation of degraded speech in noisy environments;
Healthcare:
   Stroke detection;
   Speech Therapy;
   Communicating with voice impaired patients;
Video based IVR:
   Enhanced interactive voice recognition system (e.g. interacting with a digital avatar).

### Section 2. Technology Overview

The technology is based on the principle of viseme analysis. Using visemes, the hearing-impaired can view sounds visually—effectively “lip reading” the entire human face.

The technology mimics this process by:
capturing a video of a subject speaking;
tracking and extracting the movement of the subject's lips;
performing lip reading feature extraction, such as autoencoding and/or DCT (Discrete Cosine Transform) coefficient-based feature extraction of the lip movement;
using Gaussian Mixture Model (GMM), Hidden Markov Model (HMM) and Deep Neural Network (DNN) based techniques to analyse the lip movement;
comparing the results of the analysis (on a word by word basis) with a universal model to determine what has been spoken, where the universal model is built during system installation by analysing lip movement of a large quantity of speaker videos in which the words being spoken are known.

A deep neural network (DNN) is an artificial neural network (ANN) with multiple hidden layers between the input and output layers giving the potential of modelling complex data with fewer units than a similarly performing shallow network.

Using the above techniques, key features of the system are:
the system can be trained for single/multiple speakers or be speaker independent;
the system includes unique image feature extraction and analysis methodology which enables accurate speech recognition;
lip analysis is performed using viseme based deep neural networks;
algorithm is used for merging multiple sources of audio based recognition with Liopa's VSR to optimise accuracy for all conditions.

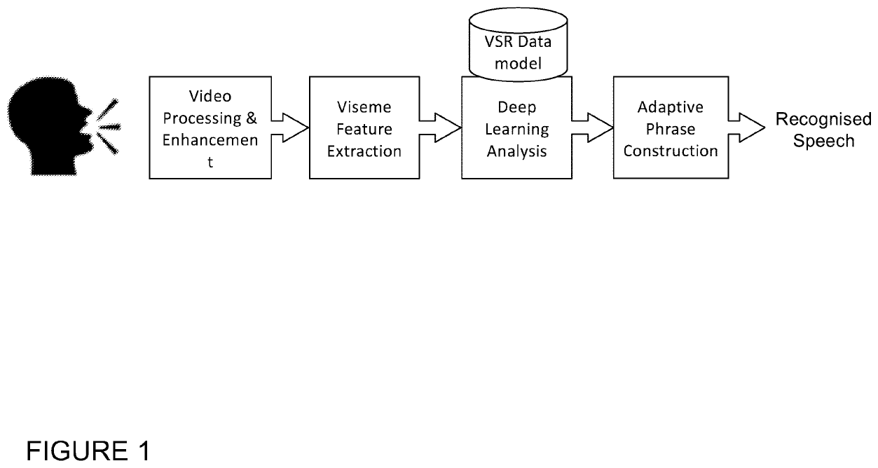

FIG. 1 is a high level block diagram of the platform based on a flexible pipeline which contains a number of functional building blocks including: video processing and enhancement, viseme feature extraction, deep learning analysis, adaptive phrase construction.

### 2.1 Liveness Check (LipSecure) Overview

LipSecure is a cloud service, which provides a liveness check to user authentication services to prevent spoofing. LipSecure can be used as a ‘liveness’ check to validate that a real person is present during any on-line interaction. For example LipSecure can be deployed with a Facial Recognition (FR) system to eradicate the common problem of ‘spoofing’ by using a static image of the user to fool the FR system. The user is prompted to speak/mime a random sequence of digits, generated by the LipSecure service, into the camera. The combined FR/LipSecure solution will validate if the user is who they purport to be and that they are actually present.

At a high level the Lip Secure system provides two main functions:
1. The capability to request and receive a random challenge phrase (e.g. a sequence of six digits);
2. The capability to submit a video of a subject speaking the challenge phrase along with the text of the phrase that the subject was requested to say. The system then returns the probability (a.k.a. confidence score) that the subject actually spoke the requested phrase. If the probability is high then a “live” person is present.

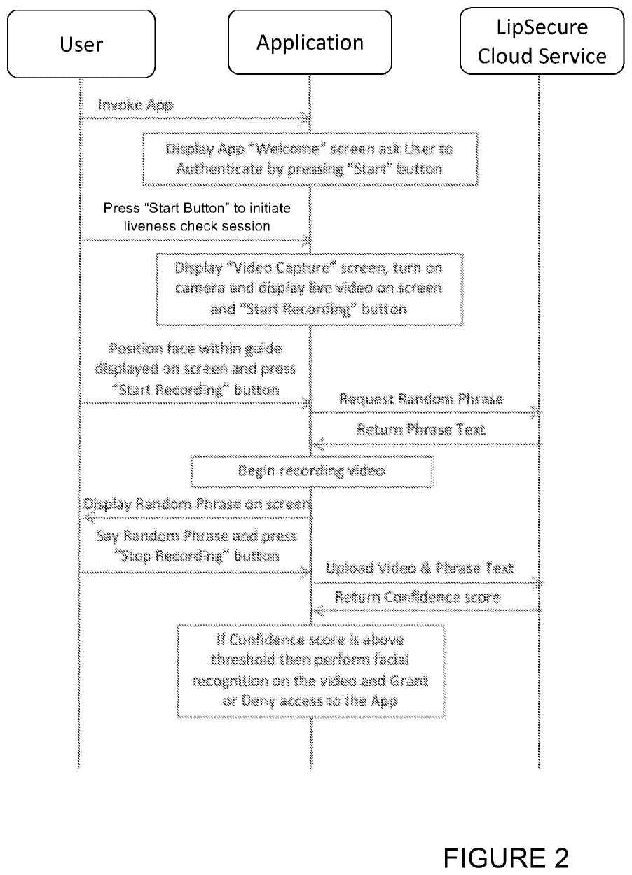

FIG. 2 is a high level sequence diagram below showing the potential interaction between an application running on a mobile device which authenticates users when the application is invoked (e.g. mobile banking app).

### 2.2 Liveness Check (LipSecure) Functional Description

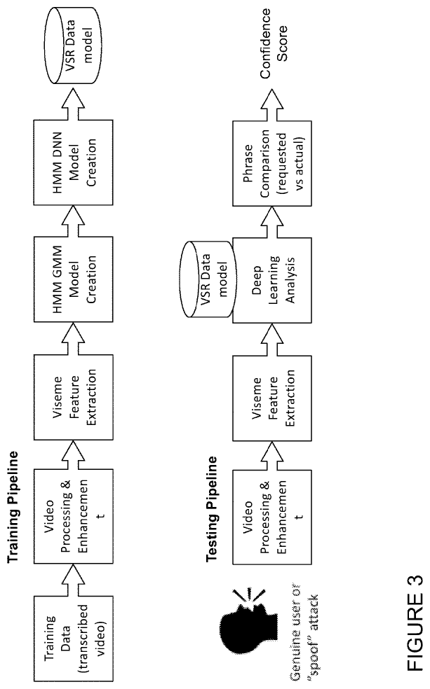

As shown in FIG. 3, an implementation of the Liopa VSR solution has two main components:
1. A training pipeline which is used to ingest large amounts of training data and create a universal VSR based model. The training data is pre-recorded videos of speakers repeating known phrases from the use case grammar—which, in the case of Liveness checking, is digits.
2. A testing pipeline which analyses videos of a user speaking to determine what they have said—and then comparing that result with the requested random challenge phrase

These pipelines are described in more detail in the sections below.

Although in the description below, DCT feature extraction is used as an example, any other lip reading feature extraction methods may be used, such as Principal Component Analysis (PCA) or Linear Discriminant Analysis (LDA).

Alternatively, a learnt feature extraction approach (such as autoencoding) may also be used where the system is trained to learn which features to extract from captured image or video data.

In this document, image or video data may refer to any image sensor data such as IR (infrared) image sensor data or depth sensor data.

### Training Phase

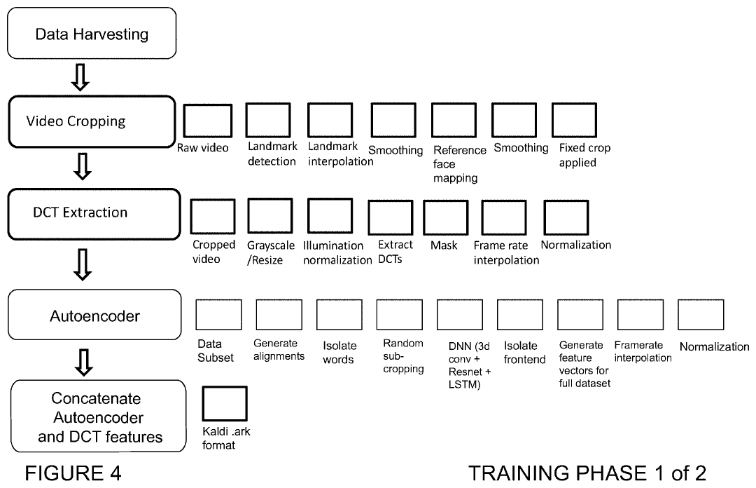

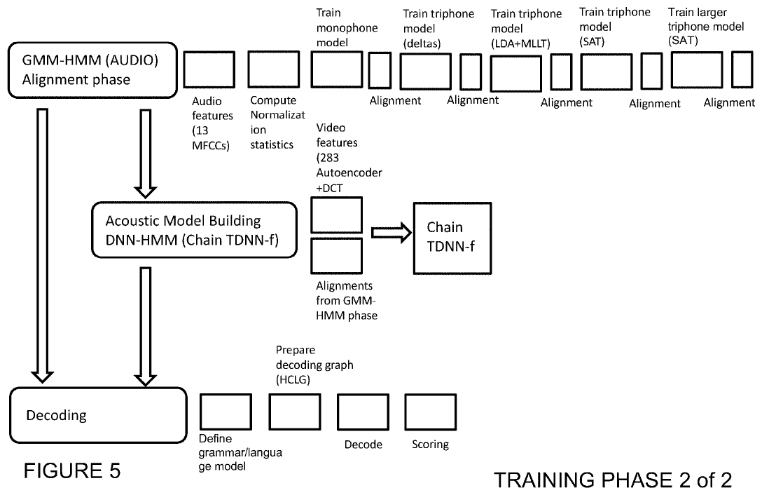

The following descriptions refer to the “Training Phase” diagram as shown in FIGS. 4 and 5.

### Video Processing

1. Input to the cropping pipeline is video of the full face of a subject which is read in frame by frame.
2. Face detection is performed on a scaled down version of each frame (where frame size is larger than specified). If a face was found in a previous frame then the detection window is limited to a specified crop around the location of the previous face.
3. Where a face is detected, facial keypoints are estimated (eyes, nose, mouth etc).
4. Where there is a gap in frames with detected faces, keypoints are linearly interpolated between successfully detected frames.
5. Window based mean smoothing of keypoints is applied across frames.
6. Keypoints are used in a perspective warp algorithm to map the face onto a reference face.
7. Where applicable, multiple detected keypoints are merged to calculate required reference points (further smoothing).
8. Fixed crop is applied to a standardised face template

### Feature Extraction—Discrete Cosine Transform (DCT)

1. Given an input of a cropped video, for each frame convert to greyscale and resize to 16×16;
2. Perform illumination compensation of choice e.g. CLAHE (Contrast Limited Adaptive Histogram Equalization) given pre-identified optimal parameters;
3. Compute DCTs;
4. Extract final coefficients to be used, e.g. triangle mask, selecting 28 coefficients via zigzag and dropping initial DCT-0 (resulting in 27 coefficients per frame);
5. Interpolate feature vectors between frames (using original video frame) timestamps) to convert to specified constant frame rate.
6. Normalize features over frames of video (subtract mean and divide by standard deviation).

### Feature Extraction—Autoencoder

1. Isolate subset of training data-set (includes a mixture of idealized lab caught data and real world on device caught data).
2. Alignments are either known in advance (ground truth) or are generated using audio data and a prebuilt model (using e.g. HTK).
3. Alignments are used to slice the cropped videos (size 96×96) into individual words for the task of isolated word recognition.
4. Data augmentation is performed on the cropped isolated word video segments which involves random sub-cropping (size 88×88) and horizontal flipping to increase data-set size and reduce overfitting.
5. An end-to-end deep neural network is implemented and consists of a front end of a set of 3D convolutions and a deep residual network, with a LSTM back end for isolated word classification.
6. Once trained on this subset of visual speech data the backend is thrown away and the front end is used to generate a feature vectors (size 256) which are interpolated to 100 fps and normalized (subtract the mean and dividing by the standard deviation) for training and test data-sets.
7. Combine normalized autoencoder features (256) and normalized DCT features (27) into concatenated feature vector of size 283
8. Output is an appropriate archive file (ark) of extracted features for each video utterance.

### Model Construction Phase

1. Current data-sets used for model construction consist of a mixture of idealized lab caught data (consisting of digit, command and more open vocabularies) and real world device caught data (consisting of digit and command based vocabularies).
2. Initial pre-processing of the data consists of extracting audio from all video files and creating appropriate transcriptions for each individual utterance.
3. From each video, features are extracted as per the process described above.
4. Using the audio corresponding to each video (that is successful during feature extraction i.e. did not fail during cropping) 13 Mel Frequency Cepstral Coefficients (MFCC) are generated. Cepstral Mean and Variance Normalization (CMVN) statistics are computed to give zero mean and unit variance cepstral (on a per utterance or per speaker basis).
5. The frame length of the final feature level audio utterance is computed and the video features are either cut or padded (using the final frame) to match this length.
6. The audio features (MFCCs) are used in the initial GMM-HMM construction for generating appropriate alignments.
7. The dictionary (lexicon) used through the process is therefore based on phonemes rather than visemes due to the use of audio in the initial model building phases.
8. Using audio features (MFCCs) a monophone HMMGMM is built, this is the first acoustic model which does not contain contextual information about the surrounding phonemes.
9. Forced alignment of audio features and transcriptions given current acoustic model to allow parameter refinement in next model building stage.
10. Build triphone HMMGMM, this is a model that includes context of the preceding and following phoneme. This is built using dynamic coefficients (deltas+deltadeltas)
11. Forced alignment of audio features and transcriptions given triphone delta model.
12. Build triphone model LDA-MLLT, Linear Discriminant Analysis-Maximum Likelihood Linear Transformation. Where LDA reduces the feature space and MLLT provides transformations, with the aim of normalization and minimizing inter speaker differences.
13. Forced alignment of audio features and transcriptions using current HMMGMM.
14. Build speaker adaptive training (SAT) HMMGMM which uses a particular data transform per speaker to standardize the data.
15. Forced alignment.
16. Build another (larger) speaker adaptive training (SAT) HMMGMM which uses a particular data transform per speaker to standardize the data.
17. Forced alignment
   Note: Parameters throughout this model building phase have been tuned to give the best performance given our training and expected test scenario.
18. A DNN-HMM model is then trained using the phoneme alignments generated from the audio features, against the autoencoder and DCT visual features. A TDNN-f chain model (NNET3) is used to this end. This is a factored time delay neural network. A chain model is a specific implementation of a DNN-HMM hybrid model within the Kaldi toolkit. There are a number of key differences within this model, the most important being that a 3 times smaller frame rate is used for network output allowing a faster decode time, and the models are trained with a sequence level objective function (LF-MMI) from the start. The key steps in training a TDNN-f include:
   a) Generate the alignments as lattices (using the most recent GMM-HMM model and audio features).
   b) Create a version of the language directory that has one state per phonemes.
   c) Build a triphone decision tree using the new topology (audio features).
   d) Generate config file for the network. This is where the architecture and key parameters are defined and tuned—including the number of layers, the dimensions (input, bottleneck and final dimensions), L2-regularization parameter on hidden and output layers etc.).
   e) Train the defined network on visual features, specifying more tune-able parameters such as learning rate schedule, dropout schedule, number of epochs etc.

Note: parameters are tuned to give optimal performance given the training set and expected test scenario. Also note that best performance in a speaker independent scenario was found without using iVectors (which are a standard feature in NNET3 Chain TDNN-f models).

### Testing Phase

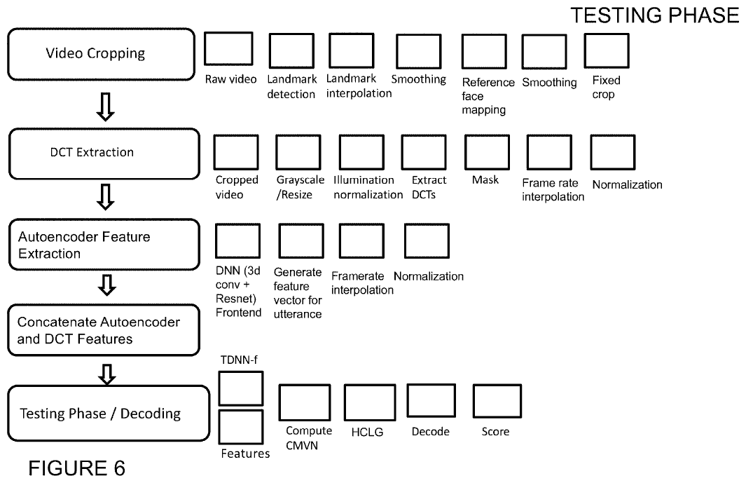

FIG. 6 is a diagram showing the “Testing Phase” components, including video processing and feature extraction, as described above.

### Testing/Decoding Phase:

1. Input: NNET3 chain TDNN-f model, a feature (ark) file for all test utterances and their corresponding transcriptions for scoring;
2. Decoding pipeline: extract features for test utterance, build appropriate grammar/language model, build decoding graph (HCLG), decode utterance using the prebuilt TDNN-f model.
3. Assuming that we have trained a model on a phonetically rich data set, we are able to use this model at test time to recognize words and phrases that have not been seen during training. To do so we add all new words and corresponding phoneme mappings to the lexicon, rebuild the language directory, build the grammar/language model (this may be a fixed grammar if our sentences at test time are limited to a specific set such as command based, or we may use a statistical n-gram language model for a more open vocabulary), build the decoding graph using all updates and the prebuilt acoustic model and then decode the test utterances.
4. Scoring is then used to provide the appropriate metric, such as word error rate, word recognition accuracy, sentence error rate, sentence recognition accuracy. An initial validation set is used to find the optimal language model/acoustic model weighting and word insertion penalty.

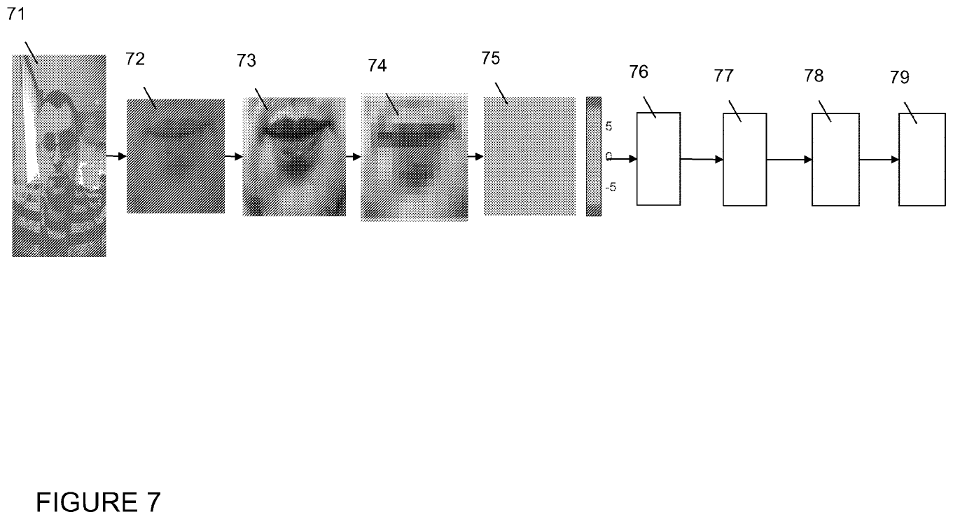

FIG. 7 illustrates an example of the feature extraction use case and shows a detailed diagram comprising the following steps performed during the feature extraction:
(71) A raw video is first received as an input.
(72) Video frames are then analysed and landmarks are detected per analysed frame or interpolated in the case where landmarks were unable to be extracted for any given frame at time points t=2:T.
(73) Illumination compensation is performed (e.g. CLAHE) whereby contrast is enhanced and hidden features of the image are made visible by evening out the distribution of grey values.
(74) the image is resized to a 16×16 image in order to obtain the most compact representation of the information provided.
(75) Discrete Cosine Transform is computed (DCTs).
(76) Triangle mask is used to extract high energy coefficients->28 DCT coefficients, dropping DCT-0 to give 27 coefficients per frame. Once again to give us the most compact representation of the most useful information.
(77) Features are normalized across frames i.e. for each DCT coefficient ranging from DCT-1->DCT-27 (subtract mean and divide by standard deviation).
(78) Interpolation is used to create more data points assuming a fixed frame rate i.e. input features represent 25 fps, we wish to have 100 fps so new features are created using cubic spline interpolation.
(79) Final features are translated into DNN format files by specifying a feature matrix and header file.

### 2.3 Confidence Scoring Algorithm

The confidence scoring algorithm is an adaptively weighted scoring process, which is based on the principle that a selection of visemes and resulting words are more difficult to identify than others, plus may be easily confused with others. The current HMM-DNN models will be used to continuously evaluate performance given a known vocabulary and test datasets. Word confusion matrices are then used to identify words that are commonly confused and with which words they are most commonly confused with, probabilities are then generated of a certain word occurring given that we have asked the speaker for a specific word. The decoding and scoring process aim to select which word/sentence is more likely given the data input/acoustic model/lexicon/language model, after having selected the most likely phrase a score is generated by comparing the predicted phrase with the asked phrase. Using a weighted scoring approach we use the probabilities identified through evaluation to re-weight this score based on which words were asked for and the likelihood of confusion seen in system evaluation.

### 2.4 Illumination Compensation

Real world applications may have a number of environmental parameters that degrade the word accuracy of a visual lip reading system. For example, under poor lighting conditions, an image or video captured may have low dynamic range, which in turn may increase the system's word error rate.

### 2.4.1 Contrast Limited Adaptive Histogram Equalization

A lip reading processing system is therefore implemented with an illumination compensation method in order to improve word accuracy in poor lighting conditions. As an example, an illumination compensation method which can be used is based on a Contrast Limited Adaptive Histogram Equalization (CLAHE) algorithm.

Histogram equalization aims to uniformly distribute pixel intensity levels over the whole intensity scale, however this can lead to over-amplification of noise. Adaptive histogram equalization aims to address this by subdividing an image into tiles or blocks and performing histogram equalization per block. To address the problem of over-amplification of noise further, CLAHE introduces a ‘clip limit’, where the histogram is clipped at a specified threshold before computing the cumulative distribution function. Neighbouring regions are then combined and blocking artefacts removed using bilinear interpolation. Therefore, CLAHE enhances visibility of local details by increasing contrast in local regions. A downfall when using CLAHE is that it is not automatic and requires parameters to be set—and is extremely sensitive to these settings. The parameters of importance are the clip limit and tile size. Current solutions have focused on the optimal setting of these parameters using image entropy. A search procedure is used whereby given a specific image CLAHE is applied at varying clip limits and an entropy curve is plotted over these clip limit values—the optimal clip limit is selected at the point of maximum curvature.

An automatic and adaptive version of CLAHE has been developed in place of a global parameter setting, where the parameters within CLAHE are selected adaptively, using image information.

The features of the AUTO/ADAPT CLAHE algorithm are as follows:
Fully adaptive parameter setting of both clip limit and tile/block size on a per frame basis within a given video.
For a given frame:
   Begin by computing optimal tile size by using a search based approach N=2:12. For each value of N compute an N×N matrix of sub-images and calculate entropy of the associated sub-images, storing the maximum entropy given all sub-images. Select N that provides maximum entropy.
   Using this optimal tile size the clip limit is now computed adaptively by using the entropy curve method.
   A number of incrementally increasing clip limits are selected and CLAHE is applied to the image using the selected clip limit (or a tile/subimage depending on the granularity of the application). The change in entropy is recorded via an entropy curve—and the clip limit associated with the maximum point of curvature is selected as the optimal setting.
   That frame is then processed using both the tile size and clip limit chosen.

### 2.4.2 a 3-Dimensional Illumination Gamma-Mask for Lighting Compensation in Lipreading Systems:

This method has been developed by augmenting a dataset with a range of lighting using frame-based gamma values.

Using an algorithm to automatically determine the lightest and darkest an image can be transformed and still make out the detail of the image, this algorithm is tailored such that it finds an optimal gamma value for each pixel (local gamma) and time point (frame) in a video to produce a 3D mask to augment each frame in training videos.

A lipreading classification model is trained with the augmented data and tested with samples from a range of lighting conditions. Using the test result's we can retain only relevant augmented data in the feature space to learn a function for augmenting illuminant robust features without prior data, storage, and memory requirements.

### 2.5 Splicing Detection—Methods to Determine Potential Attacks Through Video Splicing

A potential attack which could be employed to attempt to circumvent the LipSecure liveness verification process is to present the system a video playback of a fake video of the correct person saying the requested challenge phrase. This could potentially be produced in a variety of ways:
a. Splicing together video segments of the person saying individual digits from other videos. This could essentially produce a video which includes the correct person saying the correct digits in the correct order.
b. Creation of a DeepFake video of the person saying the correct phrase.
c. Use of a face swapping tool to map the movements of impostor facial landmarks onto the facial landmarks of the claimed speaker. This can essentially produce an animation of the claimed person saying whatever is necessary.

The detection process itself may be purely statistics based or machine learning based. A statistical approach will focus on pixel information directly i.e. the aim being to detect significant changes in pixel intensity across sequential frames (images), by studying the ‘normal’ or expected change in pixel values across frame pairs and defining an abnormality based on standard deviation and predefined thresholds through empirical studies.

A model based anomaly detection approach will first construct an appropriate model (e.g. feature extraction/HMM-DNN) to represent ‘normal’ behaviour assuming no splicing is present. Frame pairs will then be tested to identify the variation in loglikelihoods across legitimate frame pairs, compared to spliced frame pairs, where a threshold will then be determined and used to flag potential cases of splicing. The use of splicing detection may act as a component within an overall ‘quality metric’, which will consider multiple elements such as resolution, illumination, movement etc. in one final composite indicator.

It is possible to detect a video splicing attack by building a model representing the statistical norms for the appearance (e.g. this includes features of the lighting characteristics, facial feature geometry, skin tone etc.) and most importantly the frame level transitions (e.g. the velocity and acceleration of the features etc) within legitimate videos. We can then detect any frame-level anomalies which may indicate a fake video attack.

2.6 Speech Rate Detection from Lip Movements

The VSR system can produce output in various forms. One form of output is a single highest scoring utterance with word-level and phonetic-level time stamps which indicate when each word and phoneme started and stopped. From these time stamps it is possible to determine the speaking rate for an individual in a video based on the “words per minute” or “phonemes per minute” metrics. However, syllables, rather than words or phonemes, are thought to be a more stable unit of pronunciation to measure rate of speech. We therefore convert the phoneme and word sequences to time-stamped syllable sequences through a process known as automatic syllabification. We can then use these time stamps to determine a speaker's “syllables per minute” rate of speech and also measure changes in duration of a person's syllables throughout a video. A trend towards a shorter syllable duration will indicate an increased rate of speech.

These metrics can be compared either with previous data for the individual or, if no historical norms have been recorded for an individual then fluctuations within a video can be measured.

This meta information regarding how a speaker is speaking in a video (based solely on the lip movements) can potentially be used to help determine a person's emotional state during a video and perhaps help to determine individuals in a group setting who are the prominent speakers. Combined with other modalities (e.g. hand gestures, gaze angles) this could provide useful information on the group dynamics & leadership. Additionally, several studies have shown clear links between stress levels and rate of speech. Variances in the rate of speech from the historical norms found in training data could be identified and used to provide information on the tone of conversation.

### 2.7 Dynamic Time Warping Based Visual Speech Recognition

This approach to VSR is particular useful for VSR-only applications and specifically where there is a Target List of phrases which the system is expected to recognise. It is also most generally useful for applications where a user will be (or become) known to the system through regular use and where the system will be able to adapt to their specific lip movement characteristics over time.

In this application the system will be primed with a small number of instances of people saying the target phrases and these are stored as templates against which new occurrences of the phrases can be scored.

Upon first use of the system, a user may choose to record their own instances of the target phrases and these can be used as the target templates for their future interactions with the system. However even if they do not provide any explicit enrolment data to the system, it will be able to find the standard template with the greatest similarity, using Dynamic Time Warping. As the user continues to use the system, it will be able to build a profile of user specific templates which have the most reliable similarity scores.

The templates in this system are feature files extracted from the videos and represent the static and dynamic features of the persons lip appearance and movements. An optimal number of templates can be maintained for each user for each target phrase based on the K-Nearest Neighbour algorithm.

This form of VSR is particular powerful where the speakers may not be well represented in the standard training data for VSR systems. For instance, it may work particularly well for people whose lip movements have been affected by a medical condition, e.g. victims of a Stroke or for children and would therefore be ideal for inclusion as a bespoke and adaptable (silent) input mechanism for interactive toys.

### 2.8 an Automated System for Producing High Quality Data for Training a Lip Reading Neural Network.

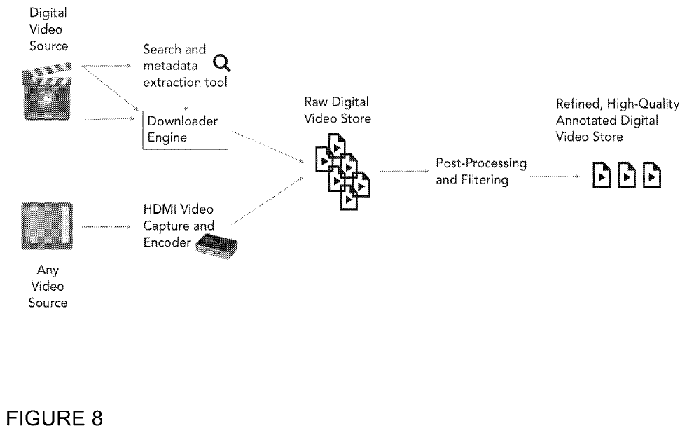

For the automated lip-reading system to function well a large quantity of training data is required. This entails building a database of hundreds of thousands of videos of people speaking along with an accurate transcription of what has been said for each video. To solve this problem, we have created an automated data generation system that can (see FIG. 8):
1. Search and download digital video sources or record from traditional video sources
2. Search the video source for suitable segments of lip movements
3. Identify the words spoken using automated speech recognition and/or transcriptions
4. Extract video segments of people speaking phrases and label them for training the lip reading system

In summary, the data generation system is an automated source of large volumes of training data for the lip reading neural network training phase.

### Data Harvesting

The data harvesting stage is responsible for creating a Raw Digital Video Store. There are two main components.

The first component is a video digitizer, that will record from any video source. This is simple, brute-force approach to obtaining digital video. The second component is a custom web-crawler that will search for video data on the internet and download it for examination. The crawler can be customized to look in specific locations and to search for particular content, e.g. videos of “talking heads”.

### Video Processing Steps

From the Raw Digital Video Store we must use post-processing techniques to filter out high-quality video material from unusable material. A video processing pipeline of increasing complexity is used to reject video that doesn't meet the quality standard. The pipeline stages are:
1. Is the video frame rate, bit rate and resolution high enough to indicate quality video?
2. Person detection→head detection→face feature detection→lip detection—is there a person in the video?
3. Face angle detection—is the person looking at the camera or looking away?
4. Speech detection—is the person moving their lips?

If the criteria of all stages in the pipeline are met the audio is considered, else the video is rejected.

### Audio Processing Steps

We judge the audio track quality to determine if the audio track is clear and free of noise. If the audio quality is low we reject the video.

Some video sources provide a text transcript. This may have been human- or computer-generated. If no transcript is available we use automatic speech recognition to produce one. Either way, we align the transcript to the video so we know what was said and at what time.

### Labelling

The last part of the data harvesting system is to take the video with all output from the previous steps to produce a refined, high-quality annotated digital video store. This store contains the following for each entry:
A video file of a person speaking which is uniquely named
A text transcript of what the person said, with time alignment
A statistical record of the person's head movements during the video
A record of where the video came from

### 2.9 Multi-Language Visual Speech Recognition

Lip reading systems which can handle multiple languages do not currently exist. Most recognise English only, other language examples are only for single languages.

Multi-lingual lipreading has two fundamental tasks: language detection, and multi-lingual modelling. A ML lipreading system could be two-tier; whereby the language is detected (this produces predictions of ‘English’, ‘French’, or ‘Mandarin’ for example) and then a language-specific model is selected to decode the speech, or a single multi-language model can detect words (or phonemes) from any language.

A significant advantage of a multi-lingual model is language-invariance at test time. This prevents a system breaking if the language changes mid conversation or mid-sentence, or for words adopted between languages. This is a particularly important point given the volumes of second language speakers in the world.

To date there is no public work on second language speakers in lip reading systems, only audio speech recognition. When we learn to speak as infant's we both listen and watch the faces of those around us. We know that mouth shapes and lip motions (visemes) change by pronunciation and content, but importantly also by language. Studies have shown that pre-lingual infants can distinguish languages by showing distress when hearing other languages thus we can infer than visual speech is similarly affected.

By learning second, or multiple languages, a speaker's repertoire of visemes doesn't change from those learned with their first language, but how they use them does, therefore if a lipreading system is to be truly multi-lingual, it will also be robust to multi-lingual speakers.

### 2.10 Speech Training Via AVSR

Audio speech recognition is used for a number of speech education tasks, for example learning second languages, child development, or rehabilitation for aphasia sufferers post a stroke. Our unique method of using visual speech as an adjunct to this task, that is AVSR for speech training, such that in addition to hearing audio during training participants can also watch videos of lip motions at different speeds. These videos which are visual gestures common for making certain sounds would assist different learners.

What makes this approach unique is exploitation of the knowledge of how visual speech varies by different age groups (and other demographic labels). Children are more likely to co-articulate phonemes in speech, second language speakers are using the same visemes for different sounds than they already know for their first language, and stroke sufferers may not have the same facial muscle use from before their stroke and thus require specialist videos/viseme simulations.

### 2.11 VSR Based Lie Detection

Face analysis for lie detection is not new, but using visual speech is. Lies are not binary, some lies are white lies, and some things we say could be true but are answers to avoid disclosing other information. Therefore analysing lip motions during speech (as we do in machine lipreading) as a face analysis for honesty detection is a unique and more probable assessment of truth in speech.

2.12 Lip Reading with Mouth Occlusions

In the real world, faces and lips are not always fully visible to a camera; scarves, hands, recording artefacts are example occlusions caused either by camera, object, or speaker motion.

Speech reading, that is, recognition of visual speech using the whole face, rather than lipreading which only uses the lips is a possible method of addressing fleeting occlusions. The lips are a complex shape which is challenging to track through a video when part(s) of it are absent. Object and face tracking are two large research topics but neither have been applied to lips in a lipreading system whereby the rest of the face can supplement information otherwise obscured by occluded lips.

### 2.13 VSR Specific Pose Invariance

The performance of real-world lipreading systems degrades where the pose angle relative to the speaker differs from that seen during training. In this sense speaker pose variation can be likened to other noise sources such as illumination variation, where the solution would typically require either additional training data to cover the variation or a method of normalisation to remove the noise.

Ensuring a system is robust to variations in speaker pose removes the constraint of requiring the speaker to adopt a steady frontal view pose towards the camera, as would usually be the case where the system has been trained on highly cooperative speakers. This opens the system up for use in scenarios where the speaker may not be aware of, or is not able, to look directly at the camera, for example where a driver is using an in-vehicle speech recognition system. It also provides scope to free up the user, allowing them to utilise the system whilst moving freely around.

Pose invariance may be built into the system at either the feature level or model level (or indeed both). Pose invariant features are particularly useful where only a single pose is available for training and expected pose variation may be reasonably limited. Such features effectively normalise for pose angle, mapping the features from a range of poses into a narrower feature space. Pose invariant visual speech models on the other hand can ultimately allow for a complete range of pose variation.

In the case of DCT based features, robustness to pose may be achieved by removing higher order and odd numbered horizontal frequency components. This has the effect of forcing horizontal symmetry and reducing the effect of yaw angle on horizontal mouth appearance. Pose invariant models on the other hand can ultimately allow for a complete range of pose variation. In the case of learned features (e.g. autoencoder), pose invariance may be achieved by training the features on multiple viewpoints for a common label.

In our system we have trained pose-dependent autoencoders which are tuned to extract features from lip videos which are from known pose angles. These were created using a unique set of ground truth videos captured using a camera rig involving multiple cameras mounted and positioned to capture the speakers face from various pose angles. The cameras are of a range of types which include standard RGB, IR, distance measurements at high frame rates. The data was captured from multiple different speakers from a diverse set of ethnicities, genders and ages to capture a rich collection of speaker appearances and dynamics.

We then train a collection of HMM-DNN VSR models for each pose using only the frame level feature representations from our pose dependent autoencoders. These models therefore have states which are tuned to recognise speech states at specific pose angles. To ensure all states in each of the HMM-DNN models for each pose represent the same physical state, we initially align the input frames and states using the audio stream frame alignments and ensure that the HMM-DMM model architectures for the audio speech recognition and VSR models are identical, i.e. the same words, lexicon, phoneme set and number of states per phoneme are identical.

Pose invariant visual speech models can ultimately allow for a complete range of pose variation. This can be either through a single, general purpose model trained on all available poses in conjunction with pose invariant features, or via multi-stream modelling where each stream represents a subset of pose angles and may be selected dynamically during recognition. Such a dynamic selection can be performed at the frame level using the posterior probabilities of a frame to determine the most likely model and any given time. The single model approach is better suited where there is an uneven distribution of pose angles in training, or where the pose angles in training are unknown. The multi stream model on the other hand presents the potential for highest lipreading accuracy across views but requires more controlled training data, the use of each technique is dictated by the specific end use and availability of data. In our system we have developed an approach to pose-invariant VSR as follows:
We assume the person is facing towards the camera or is within 90 degrees of the camera, i.e. the person is in frontal view or side on to the camera or at any angle in between but the face is visible and the mouth is also detectable in all frames.
The head is detected and the mouth region of interest (ROI) is extracted automatically.
The ROI frames are then passed to the collection of autoencoders which have been trained on known pose angles and the feature representations for each are collected.
These frames are then scored using each of the tuned HMM-DNN models to calculate the frame-level likelihood for each pose.
The maximum likelihood score is determined as the most likely pose at that moment for each possible state in the HMM-DNN system. However, all state scores are maintained to allow smoothing at the end of the sequence of frames. This smoothing will ensure that inter-frame pose changes are within reasonable limits, i.e. a constraint may be put on the expected rate of change for pose changes such that that poses wouldn't be expected to change excessively from one frame to another, e.g. not by than 30 degrees.
This system provides an intelligent way to combine the outputs form multiple VSR models which dynamically adapts to the pose appearance of the person captured via a single camera.

### 2.14 Visual Speech Recognition Approach to Non Repudiation of Online Transactions

Traditional approaches to non repudiation have centred on highly sophisticated encryption systems aimed at proving that the origination and destination of on line transactions can be verified—and that data transferred between those two points has not been tampered with. These systems are highly complex and are impractical for resolving repudiation situations as they (1) are not understood and rarely used by the vast majority of internet users (2) are vulnerable to malware attacks on the end point devices (3) do not verify which actual individual carried out which actions (4) are of no benefit in repudiation disputes as data available on completed transactions is too complex to be understood e.g. by a jury in legal scenarios

Liopa has developed a VSR based non repudiation system as an alternative to digital signatures and encryption, to provide a seamless and user friendly method for securing on line transactions and agreements. This combines Facial Recognition based user authentication with Audio Visual Speech Recognition (AVSR). AVSR is leveraged to prevent authentication spoofing and to verify that an important phrase or sentence which is required to be spoken during e.g. a legal or online commerce transaction has been recited correctly. The automatically authenticated video of the recital is then stored as proof of the transaction completing successfully and used as evidence in any future repudiation dispute.

The key areas of innovation in this system are (1) the use of the AVSR system, which will leverages DNN based audio and video speech recognition techniques to ensure that speech is recognised accurately in all environmental conditions e.g. high levels of background noise or variable lighting etc. (2) the integration of Facial Recognition with VSR based anti-spoofing technology which can verify that the actual authenticated user is present during the transaction (e.g. prevents “replay” attacks).

The following potential use case demonstrates how such as system could be leveraged in practice: a user is interested in purchasing health insurance and the insurance provider wants to provide an automated service which is entirely on line and involves no exchange of paper documents. The user sets up an online account with the insurance company by providing a copy of photographic ID and reciting a confirmation phrase which is recorded by the camera on their computer or smartphone/tablet. The confirmation phrase is verified and the user is enrolled into the Facial Recognition system. Then, during a transaction to purchase insurance, the user is asked to confirm key pieces of information and to agree to certain restrictions and terms & conditions. At these points video of the recitals is captured, the user authenticated and what is said is checked for correctness. These recitals are then stored in the insurance companies system for future use. During the term of the insurance the user makes a claim which the insurance company believes is not valid e.g. due to a pre-existing health condition. The insurance provider is able to deny the claim and provide verified video evidence from initial purchase transaction which the user is not able to successfully challenge.

### 2.15 VSR Based Speech Recognition App for the Voice Impaired

SRAVI (Speech Recognition App for the Voice Impaired) is a communication aid for speech-impaired patients, such as patients with tracheostomies. The SRAVI app can run on any Android device (smartphone, tablet) and, when held in front of the patient, will track lip movement and identify phrases being mouthed.

Compared to alternative approaches, which are expensive and need prolonged training to use, SRAVI can provide an easy-to-use, accurate and cost effective method for communication between patients, their family members and healthcare staff. By establishing a simple, reliable way of expressing themselves patients are able to better liaise with staff to secure the care they need.

SRAVI is based upon Visual Speech Recognition (VSR) technology. A video of the patient's lip movements is captured by the device camera and sent to Liopa's cloud-based VSR engine for processing. The phrase being spoken is identified from a pre-defined list and an audio recording of the phrase is played on the device. The pre-defined phrase list can be expanded and varied in accordance with the care setting (e.g. hospital or home-based). SRAVI can adapt to an individual patient's lip movements over time, which means it becomes increasingly accurate the more it is used.

SRAVI is simple to use as no arduous training for patients or families are required. End-users only have to move their lips in front of the device and the app provides an instant translation of what they want to say. Family members are able to access the system and interact more freely with the patient.

### 3. Audio-Visual Speech Recognition System.

An Audio-Visual Speech Recognition (AVSR) system combining audio speech recognition and VSR is now described. The AVSR system may include a VSR system implementing any of the features described above.

VSR technology can also be combined with audio speech recognition techniques to provide an optimal accuracy across varying levels of audio and video noise.

We have developed 3 methods for integrating audio speech recognition with visual speech recognition. They are listed below:
Target-Phrase Scoring based on Cumulative N-Best List Similarities
Lattice Merging based on Phrase Similarities
Frame-level MWSP Integration

### 3.1 Target-Phrase Scoring Based on Cumulative N-Best List Similarities

This approach is particularly useful for problem domains where it is expected that a user will utter a phrase from a specific list of Target phrases. While it would be preferable for the audio speech recognition and VSR systems being integrated to have been designed and tuned to specifically recognise only the target phrases, that is not essential for this integration approach to work. The outputs form the audio speech recognition and VSR system can include phrases which are not found in the Target phrases.

This approach requires the following inputs:
a. The set of target phrases which the system is expected to recognise
b. The N-Best lists of phrases which are produced by the audio speech recognition system and the VSR system

The process works in the following way:

The N-Best lists from the audio speech recognition and VSR engines are ranked separately according to likelihood or probability. The lists produced by each system should be of equal length and ideally will contain a minimum of approximately 10 phrases. If one list initially contains more phrases than another then two approaches can be used to balance this. The simplest approach is to remove lower ranked phrases in the longest list to ensure equal lengths. The second is to use a phrase similarity weighting which normalises the effect of more scores coming from one modality than the other. E.g. if one list contains 10 phrases and the other contains only 7 phrases then each similarity score from the list of 10 phrases can be weighted by multiplying be 0.1 (i.e. 1/10) and the similarities recorded from the other list of 7 phrases can be weighted using 0.143 (i.e. 1/7).

The phrases in each N-Best list are taken one at a time and a similarity score is calculated against each of the target phrases. The similarity score can be calculated in a variety of ways but the key calculation is the edit distance between the two phrases. The edit distance can be calculated based on the word tokens in the phrases or can be extended to include the phonetic edit distances. The edit distance is then converted to a normalised similarity measure S based on the following formula:

S=1−(E/L)

Where E is the token edit distance and L is the length of the larger of the two phrases in tokens (words or phonemes).

### Word-Level Edit Distances

For word level edit distances, the words in a target phrase are aligned with the words in the recognised phrase using Dynamic Programming to find the word mapping which minimises the Levenshtein edit distance between the two phrases.

### Phonetic-Level Edit Distances

For phonetic edit distances, the words in the mappings are converted to phoneme strings using a pronunciation lexicon. A Levenstein distance or alternatively a Jaro-Winkler distance can then be calculated between the phoneme strings instead of the word strings. Calculating the edit distance at this level is preferable to the word level distances as it will help to reinforce the likelihood of target phrases which are phonetically similar to the recognised phrases but that perhaps have the wrong word tokens. E.g. if the target phrase list contains the phrase “Ice cream” and the recognised phrase in the N-Best list “I scream” then with word level similarity for the target phrase would be 0. However, when using phonetic edit distances these word level phrases would convert to “AY S. K R IY M” and “AY. S K R IY M” where the full stop indicates the recognised word boundaries. The edit distance in this case would be 0 and the similarity would be 1.

This lower level phonetic edit distance also allows the audio speech recognition and VSR systems to produce phrases with a much wider vocabulary than the potentially limited vocabulary in the Target list. Therefore “general purpose” large vocabulary audio speech recognition or VSR systems can be integrated and the outputs can be refocused towards a Target list without any retraining of the audio speech recognition or VSR systems.

### Cumulative Similarity Score

A cumulative similarity score is maintained for each target phrase. This is the sum of all the similarity scores from all phrases in the N-Best lists from both the audio speech recognition and VSR system. Once all phrases have been scored against all target phrases, the target phrases are ranked according to their cumulative similarity scores. The similarity scores may be normalised at this point if it is necessary or expected by any future processing unit. The topmost phrase may be the output of the system or the entire ranked list of target phrases may also be the output with their associated similarity scores used to indicate the likelihood for each target phrase.

### Modality Reliability Weightings

It is also possible to apply further weightings to each individual similarity score which is produced based on phrases from each modality. These weights would allow the measured or anticipated relative reliability of the modalities (audio speech recognition and VSR) to be taken into account in the ranking of phrases. For instance, if a high level of audio noise is estimated at recognition time or perhaps it is expected based on the deployment scenario (in a noisy environment), then it would be possible to apply fixed ‘reliability’ weights to the audio speech recognition phrase similarities of 0.6 (a value between 0 . . . 1 where 0 indicates a modality perceived as entirely corrupt and 1 is entirely reliable) while applying the weight of 0.9 for each similarity calculated based on the VSR modality. These weights will have the effect of emphasizing the similarities calculated for VSR phrases against the targets and de-emphasizing the similarity of audio speech recognition phrases. Likewise, if corruption or noise is detected in the video signal which would affect the reliability the VSR output e.g. very poor illumination, then a lower reliability weight could be applied to the VSR phrase similarities.

### 3.2 Lattice Merging Based on Phrase Similarities

This approach is useful if the problem domain is more general purpose and there is no specific list of target phrases.

This approach requires the following inputs:
a. The N-Best lists of phrases which are produced by the audio speech recognition system and the VSR system

The process works in the following way:

A phrase lattice is created and updated by taking the phrases from the audio speech recognition phrase list (ranked from highest likelihood to lowest). Each phrase is mapped to the current lattice nodes and edges to find the path through the lattice with the minimum edit distance to the current phrase. If new nodes are required to add specific tokens to the lattice then they are added at this stage. The edge weights between the nodes in the lattice are updated to account for the new occurrence of the tokens along the lattice path. This means that the pathways through the lattice which contain the most frequently occurring sequences of words will accumulate the strongest weights. When the phrases are all added then the VSR phrases are added to the lattice in the same way. This produces a large lattice which contains all of the paths representing the phrases in both lists. It is important to note that potentially this larger lattice may include paths which represent phrases that were not found in either list of phrases on their own. This characteristic may be important for situations where the audio speech recognition system has been highly confident about the words at the start of a phrase and produces reliable results whereas the end of the phrase is poorly recognised where as the VSR system perhaps was unreliable for the start of the phrase and highly reliable for the end of the phrase. This integration approach has the potential to generate a new correct phrase pathway which is based on the audio speech recognition phrases at the start and the VSR phrases at the end.

A final step in this approach is to potentially rescore the lattice paths again using a specific Language Model which has been tuned towards the problem domain in use. This allows the most grammatically likely phrase to be found from the large list of possible phrase pathways.

### 3.3 Frame-Level MWSP Integration

This final low level integration approach is potentially more powerful than the other higher level approaches for two reasons:
a. The combination can happen during the initial decoding pass of the system through the audio and video frames whereas the other late integration approaches cannot begin until the full outputs are produced from their individual decoding processes.
b. The system can be more adaptive to short term corruptions/noise in either modality.

A range of potential algorithms can be applied to combine the scores from each modality. The approach we take is based on the Maximum Weighted Stream Posterior (MWSP) algorithm (Seymour, R.; Stewart, Darryl; Ji, Ming./Audio-visual Integration for Robust Speech Recognition Using Maximum Weighted Stream Posteriors. Paper presented at Interspeech 2007, Antwerp, Belgium, pp. 654-657).

If an AVSR system can be assumed to be operating in a stable acoustic environment (quiet and unchanging noise levels) and with stable video conditions (e.g. with little camera movement and unchanging illumination conditions) then it would be possible to determine at design-time an optimal static weighting which should be applied when combining the systems. Some research has shown that a fixed weighting of perhaps 0.7 for the audio stream and 0.3 is effective. This is due to the fact that the audio stream generally provides greater discriminative information than the visual stream. However, in real-world conditions where the noise level and therefore reliability of the two streams may fluctuate due to changing noise levels, the AVSR system must aim to maintain robust performance by modifying the weightings which are applied.

The MWSP algorithm has been shown to offer some ideal characteristics in that it produces recognition performance (Word Accuracy) which is at least as high and potentially higher than the best of the individual modalities when operating in both quiet or noisy conditions. Other key benefits of the algorithm are that it allows the system to dynamically optimize the weights which are applied when combining the probability outputs from the Audio and Visual modalities without the need to explicitly measure the level of noise or corruption present in either modality. The weights can be optimised for every input frame of audio and video. This means that there is no requirement at training- or design-time for the system to know anything about the noise types or levels which will be present in the specific environment in which the system will be deployed and it can be deployed in applications where the noise types and levels in either or both modalities may be time-varying.

In the published papers, the effectiveness of the MWSP algorithm is demonstrated within a Multistream Hidden Markov Model system which used Gaussian Mixture Models to represent the HMM states. However, the MWSP algorithm can equally be applied within other modelling architectures including HMMs with Deep Neural Network state representations.

### APPENDIX 1. CHALLENGE BASED VISUAL SPEECH RECOGNITION USING DEEP LEARNING

We present a novel approach to liveness verification based on visual speech recognition within a challenge-based framework which has the potential to be used on mobile devices to prevent replay or spoof attacks during Face-based liveness verification. The system uses model visual speech recognition and determines liveness based on the Levenshtein Distance between a randomly generated challenge phrase and the hypothesis utterances from the visual speech recognizer. A Deep learning-based approach to visual speech recognition is used to improve upon the state of the art for the use of visual speech recognition for liveness verification.

### I. Introduction

Alternatives to the use of passwords are increasingly being considered as means of securing access to electronic devices such as laptops and phones. The most common approaches towards user authentication for gaining access to these devices make use of passwords, user IDs, identification cards and PINS. These techniques have a number of limitations: Passwords and PINs can be guessed, stolen or illicitly acquired by surveillance or brute force attack. There have been many high-profile hacks emanating from password breaches in recent times. These hacks allow malicious individuals to gain access to a system using the credentials of a valid user without the user being present.

In order to enhance security, alternatives to the passwordbased approaches have been considered and these have primarily been focused on forms of Biometric authentication. A number of different biometrics have been proposed, with the most popular involving recognition of the Face [1], Voice [1] or Fingerprint [1][2]. These systems, while more secure than passwords, also have some limitations. Fingerprint scanning systems are accurate, fast and robust, however, they can be susceptible to forms of ‘spoofing’ whereby false fingerprints, can be used to fool the sensor [2]. A further limitation is the additional cost of having a dedicated fingerprint sensor within the device means that few devices have offered fingerprint scanning as an authentication process.

Speech recognition systems can be deployed inexpensively and universally to all mobile device types as they use only the standard microphone in the device. Voice has been shown to be highly accurate and reasonably robust in quiet environments. The performance can be affected by the presence of loud and/or time-varying background noises. Furthermore, in some environments, it may be considered inappropriate or indiscrete to speak clearly into a microphone.

Face recognition has been shown to be highly accurate and can be robust to changes in the user's environment, appearance, variations in pose and illumination conditions. A key concern with face recognition systems is that they may be susceptible to spoofing attacks where an unauthorized user holds a photograph in front of the camera and gains access as the person in the photo [3]. These forms of attack are more likely to be successful in the unsupervised, remote access use cases involving mobile devices. The security of remote unsupervised face recognition systems would be significantly improved by ensuring that “liveness” detection is included in the authentication process, thereby ensuring that the authorized user is present and responds when prompted for input by the system.

In this paper, a means of liveness verification based on visual phrase verification algorithm which uses a visual speech recognition system within a challenge-based verification framework. Specifically, the process of verification involves the user being challenged to say a randomly generated string of digits which they will then speak into the phone's camera. Visual speech recognition will be performed on the video and if the visual recognition system is confident that the video contains lip movements which match the challenge phrase, then the liveness' of the user will be verified. The challenge phrases are randomly generated at each verification attempt to limit the possibility of replay attacks using previously recorded videos.

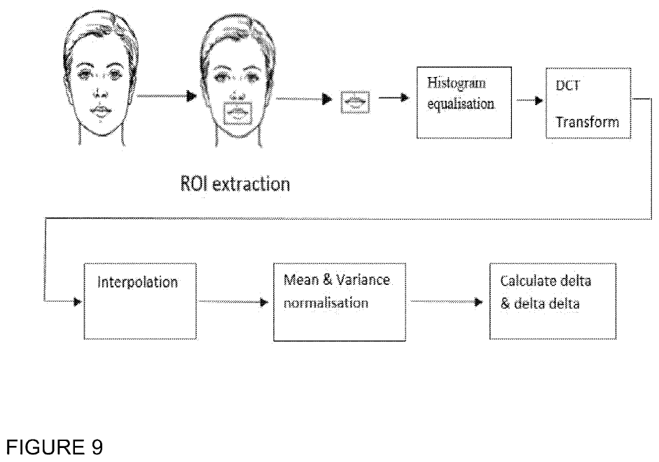

FIG. 9 is a diagram illustrating the feature extraction process.

For practical use, this approach to liveness verification would be combined with other biometric authentication processes such as face recognition in order to improve the overall security and robustness of the biometric system and would not inconvenience the user significantly beyond the standard face capture process. Visual speech recognition has been the focus of extensive research in recent years and has matured to the point that it can be used robustly for limited vocabulary tasks [4][5]. Prior research on the use of visual speech recognition for biometric applications have focused on the use of the visual information combined with audio [6][7] and most of the research has focused on using visual speech as an alternative means of verifying the user's identity not for verifying liveness. Evano and Besacier [8] investigated liveness verification based upon an analysis of the synchronicity of visual and audio features and reported an Equal Error Rate of 14.5% using the XM2VTS dataset. In [10] a liveness verification system based on only using visual information was proposed that is based on speech recognition with an SVM (support vector machine) to recognize digits that had been individually segmented. A speech recognition rate of 68% was reported on the XM2VTS dataset, using the approach in [10] with only the visual modality. In this paper, the aim is to show an improvement over previous works through the use of deep learning

### II. Visual Speech Recognition

Visual speech recognition aims to determine the text spoken by an individual based on the movement of their lips.

When a visual speech recognition system receives a video the first step to performing recognition is first to determine where in the images the lips are located and to extract the lip region to be used as the region of interest (ROI). For the system that is used in this paper, the Dlib image processing library was used [9]. Dlib provides a facial landmark detector that has been used to located and extract the ROI from each video frame, this process is described in [9].

The DCT transform was chosen as it was shown to give good performance in [5]. A triangular mask is then applied to the result of the DCT transform and from this the 15 lowest frequency coefficients are selected with the DC component being removed, leaving 14 DCTs. The DC component is removed as initial experiments showed that the system performed better when the DC component was not present. Mean and variance normalization is then applied to the feature vectors. The number of features is increased through cubic spline interpolation to 100 fps, as this was found to increase the performance of the visual speech recognizer. From the 14 DCTs, differential and acceleration coefficients are calculated. These are then concatenated with the 14 DCTs to give a feature vector of 42 coefficients.

Deep learning approaches have shown promise in solving problems in areas such as computer vision [11] [12], audio speech recognition[13] and natural language processing [14]. In order to create a visual speech recognition system that is capable of performing to a level comparable with audio based speech recognition software a deep learning based approach was chosen. By incorporating such an approach, the aim is to produce a system that would be suitable for real-world applications.

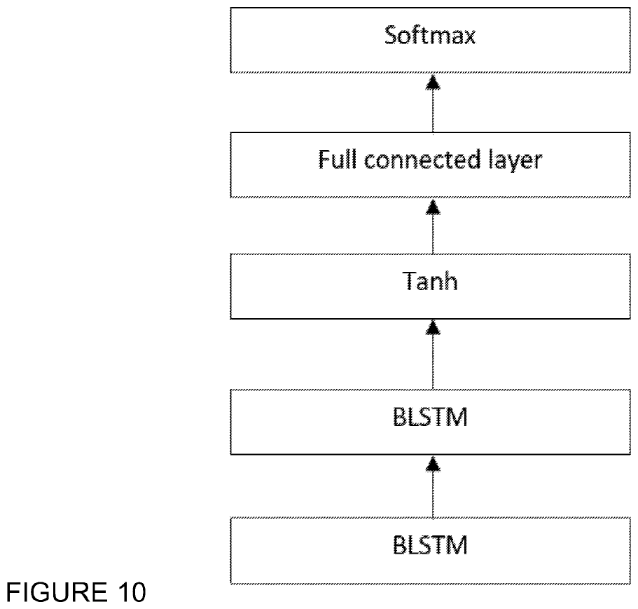

For this work, we have employed a hybrid system for performing visual speech recognition. The term hybrid refers to a speech recognition system in which a DNN (deep neural network) and HMM (hidden Markov model) are combined [15]. The DNN is used to provide the posterior probability estimates for the HMM states. The HMM models the long-term dependencies needed to take account of the temporal dimension of speech. For this work, we employed a DNN-HMM trained on DCT features. The use of DNN-HMM recognizers has shown significant improvement in the performance of speech recognition systems over prior approaches [13] [16]. The architecture of the DNN can be seen in FIG. 10.

Prior to training the DNN a DBN (deep belief network) of stack RBMs (restricted Boltzmann machines) was trained. This process is used to initialize the parameters of the hidden layers in the DNN. This is done via a greedy layer-wise procedure with each RBM trained and then stacked to produce the DBN. The RBM's are trained via approximate stochastic gradient descent. After this pre-training step, the DNN is trained using sMBR (state level minimum Bayes risk) sequence discriminative training as this is suggested as the best criteria for sequence discriminative training in [17] [18].

### III. The Liveness Verification Algorithm

The output of a speech recognition system is a single highest-likelihood hypothesis phrase and the performance of a recognition system is commonly measured by performing recognition on a set of test utterances and calculating its average Word Error Rate (WER) [19]. WER for a single test utterance is calculated as

WER=S+D+1/N (1)

Where S is the number of substitution errors found in the hypothesis phrase, I is the insertion errors, D is deletions errors and N is the total number of words in the correct transcription. S, D and I are determined through the use of dynamic programming during the calculation of the Levenshtein distance between the correct transcription of the spoken utterance and the hypothesis phrase.

Ideally, when a speaker says the challenge phrase the result of visual speech recognition would be a perfect match but visual speech recognition is not yet perfect and typically may operate at WERs of between 10%-40% depending on the user and the quality of the video provided. Therefore, given that a recognition system will operate at a certain average WER, it seems plausible that if a challenge phrase of sufficient length is compared to the output of the recognizer and the Levenshtein distance is within an Acceptable Levenshtein Distance (ALD) threshold then it could be postulated that the challenge phrase was probably spoken as opposed to a random phrase and therefore liveness could be verified. Given this setup, the probability of a successful spoofing attack using a video containing the correct number of random digits can be expressed as in Equation 2.

$$P = \frac{{1}^{w - ɛ}}{w} \cdot \frac{{v}^{ɛ}}{w} \cdot ( \begin{matrix}W \\ ɛ\end{matrix} ) \qquad ( 2 )$$

Where P is the probability of a match being found with a challenge phrase containing w words chosen from a vocabulary of v+1word types and where the system allow ε errors. Taking a specific example, the probability of a random digit string video being used successfully for a spoof attack where w=20 and e=12 is 3.4×10⁻¹⁰. Therefore, while ideally the ε would be kept as low as possible, even where the recognizer is not completely accurate.

### IV. Lattice-Based Phrase Verification.

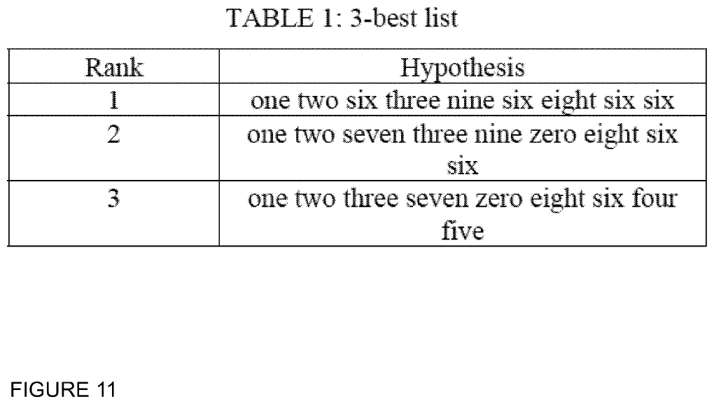

Aside from the single highest-likelihood hypothesis phrase, it is also possible to generate an N-best list of phrase hypotheses ranked according to their likelihoods from what is known as the recognizer's search lattice. The N-best list typically includes phrases which are plausible slight variations of the highest ranked hypothesis. For example, if a user was challenged to say the following phrase: “one two seven three nine zero eight six four” then the resulting 3-best list might be as shown in table 1 (FIG. 11).

As can be seen in this example, the second-ranked hypothesis contains fewer errors than the best hypothesis and it is not unusual for the correct transcript or a close match to it to be found elsewhere within the N-best list rather than at the very top. The maximum length of an N-best list is primarily determined by the beam width and other pruning parameters during recognition but in practice, the correct phrase is generally found close to the top and in our experiments always within the top 50 phrases. Therefore, we allow the system to perform phrase verification with each of the hypothesis phrases in the top 100 phrases and if any of the phrases are verified based on the search of the N-best list, then the liveness is determined to be positive. This potentially allows the ALD threshold to be reduced slightly leading to a reduction in False Rejection Errors (FRR).

### V. XM2VTS Dataset

For the experiments, the XM2VTS dataset [20] was chosen. The XM2VTS dataset is a multi-model dataset comprised of 295 speakers saying the phrases “zero one two three four five six seven eight nine”, “five zero six nine two eight one three seven four” and “Joe took father's green shoe bench out”. The focus of our experiments is on digit recognition by visual speech recognition so only the digit string phrases have been used. The data is split between training and testing data based on the Lausanne protocol [21]. This protocol divides the dataset into training and test for the training and testing of biometric systems. The protocol specifies two distinct configurations for the dataset. We use Configuration II of the protocol as the starting point for selecting our training and test data. Specifically, we selected the videos from the 70 speakers in the test partition as our test data for the speaker independent liveness verification experiments. The videos from the speakers that are not in the test set are used when training the recognizer. As none of the videos from the speakers present in the training set were used for our experiments the results reported indicate how the system would perform under speaker independent conditions and are therefore a good indication of how the system would perform when presented with data from new speakers, as would occur when such a system would be deployed for practical use.

The two 10-digit sequences were combined within one video to give the 20-digit phrase “zero one two three four five six seven eight nine five zero six nine two eight one three seven four”. Only the 20-digit videos were used during training of the recognizer. Using this model, a word accuracy of 86.3% was obtained using the 20-words videos. To allow for investigation into the effect of varying the length of challenge phrases, we segmented the videos in the test set to generate new videos from the test data which contained digits strings of 6, 10 and 15 digits.

This was achieved by segmenting the 20-digit videos into videos containing shorter phrases based upon word boundaries for each digit in the video. These were obtained by performing forced alignment of the audio from the videos using a highly accurate (99% word accuracy) audio-based speech recognizer. A variety of phrases were generated using these boundaries by moving a window of size w one word at a time over the 20-digit phrase. As a result of generating the videos based on this approach, it was possible to expand the number of phrases that were used in our experiments. The variety of phrases can be seen by looking at the first few 10-digit videos generated from the original 20-digit videos were “zero one two three four five six seven eight nine”, “one two three four five six seven eight nine five”, “two three four five six seven eight nine five zero” etc/While running the experiments, each video was tested as a possible spoof attach case and as a valid user test. The spoof attacks where set up as 1000 random challenge phrases of the correct length containing digit strings that did not match the actual content of the video were created. This simulates the possibility of an attack where the attacker poses a video of the correct user saying a phrase different to the one the system prompts the user to say.

### VI Experiments

Experiments were conducted using the visual speech recognizer on videos containing different length phrases. For practical use, a shorter phrase is preferable as it would take less time for a user to say, however, a longer phrase might be desirable where a stronger level of security is required.

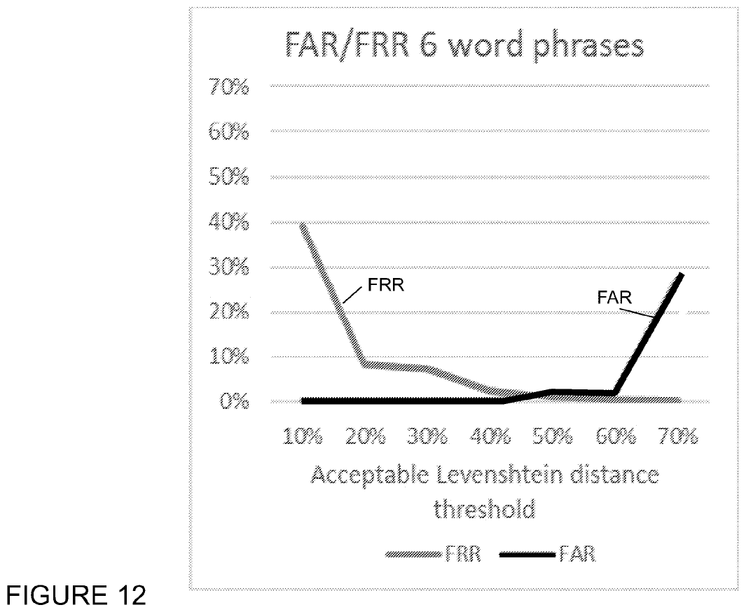

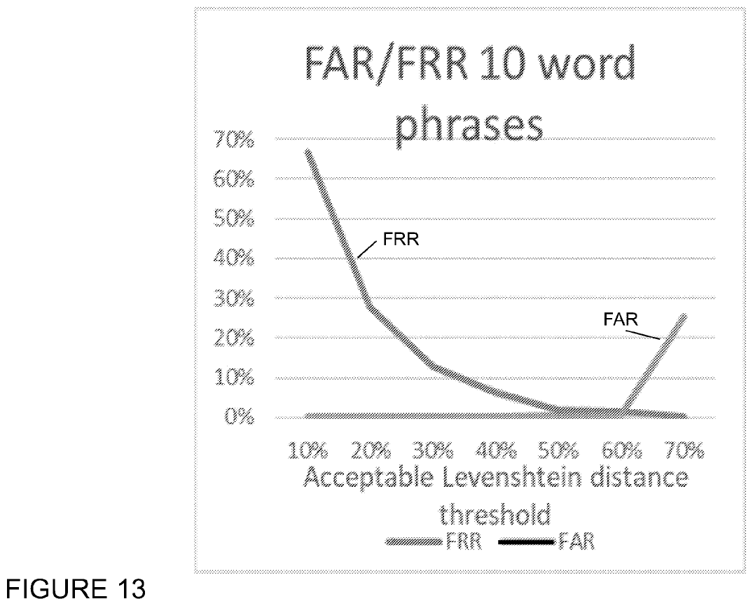

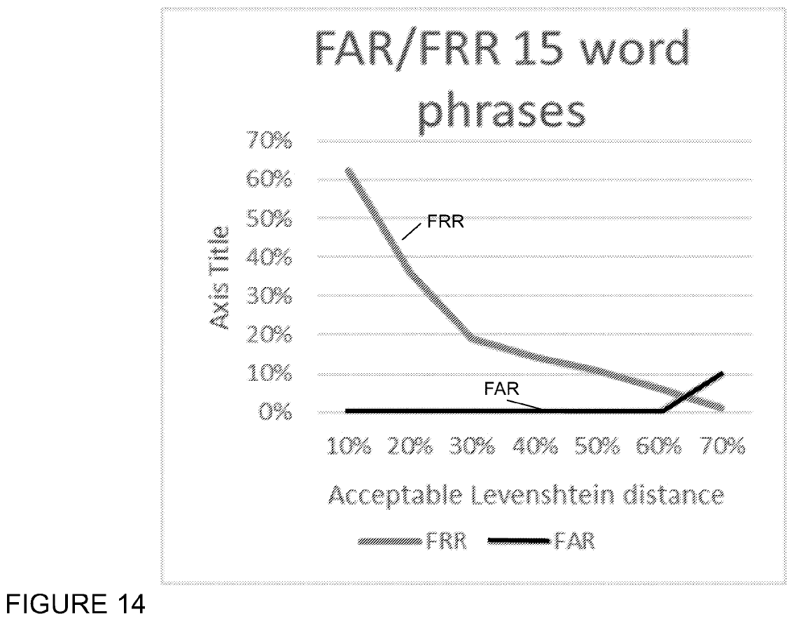

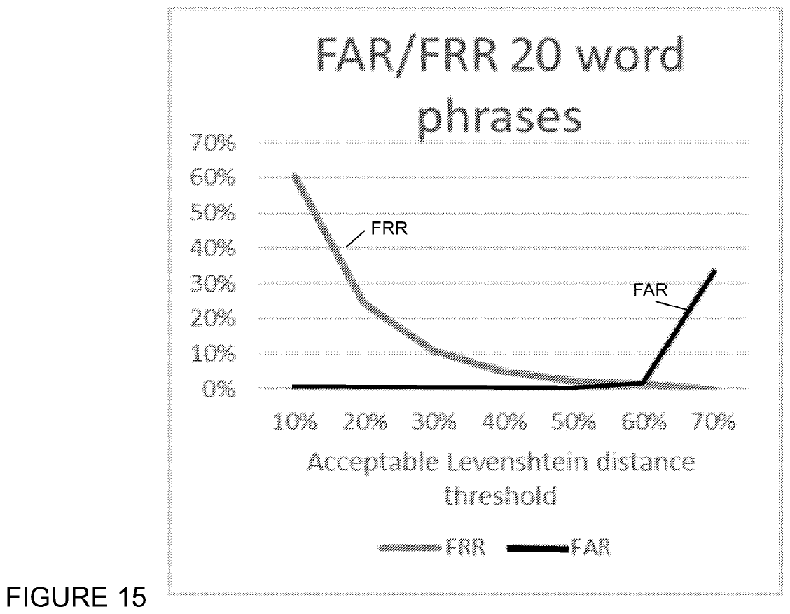

The average durations for the videos of 6, 10, 15 and 20 words in length were 2, 4, 6 and 8 seconds respectively. The results of the experiments can be seen in FIGS. 12 to 15. These charts show the FRR (false rejection errors) and FAR (false acceptance rate) when the ALD threshold is set to different values. It is shown that the FRR stays below one percent even with ALD thresholds as high as 40%.

VII Future work

In this work, the use of deep learning based visual speech recognition as the basis for challenge-based liveness verification has been investigated. The performance of the system on a variety of phrase lengths has been shown and the appropriate ALD thresholds for the different phrase lengths are indicated. Future work will look at improving the performance of the visual speech recognition system and how to make it more robust to noise that such system would encounter when used in real world conditions.

### APPENDIX 1 REFERENCES

[1] Jain, Anil K., Arun Ross, and Salil Prabhakar. “An introduction to biometric recognition.” IEEE Transactions on circuits and systems for video technology 14, no. 1 (2004): 4-20.
[2] Roberts, Chris. “Biometric attack vectors and defences.” Computers & Security 26, no. 1 (2007): 14-25.
[3] Biggio, Battista, Zahid Akhtar, Giorgio Fumera, Gian Luca Marcialis, and Fabio Roli. “Security evaluation of biometric authentication systems under real spoofing attacks.” IET biometrics 1, no. 1 (2012): 11-24.
[4] Dupont, Stephane, and Juergen Luettin. “Audio-visual speech modeling for continuous speech recognition.” IEEE transactions on multimedia 2, no. 3 (2000): 141-151.
[5] Pass, Adrian, Jianguo Zhang, and Darryl Stewart. “An investigation into features for multi-view lipreading.” In Image Processing (ICIP), 2010 17th IEEE International Conference on, pp. 2417-2420. IEEE, 2010.
[6] Chetty, Girija, and Michael Wagner. “Biometric person authentication with liveness detection based on audio-visual fusion.” International Journal of Biometrics 1, no. 4 (2009): 463-478.
[7] Alam, Mohammad Rafiqul, Mohammed Bennamoun, Roberto Togneri, and Ferdous Sohel. “A joint deep boltzmann machine (jDBM) model for person identification using mobile phone data.” IEEE Transactions on Multimedia 19, no. 2 (2017): 317-326.
[8] Eveno, Nicolas, and Laurent Besacier. “A speaker independent” liveness” test for audio-visual biometrics.” In Ninth European Conference on Speech Communication and Technology. 2005.
[9] Kazemi, Vahid, and Josephine Sullivan. “One millisecond face alignment with an ensemble of regression trees.” In Proceedings of the IEEE Conference on Computer Vision and Pattern Recognition, pp. 1867-1874. 2014.
[10] Benhaim, Eric, Hichem Sahbi, and Guillaume Vitte. “Designing relevant features for visual speech recognition.” In Acoustics, Speech and Signal Processing (ICASSP), 2013 IEEE International Conference on, pp. 2420-2424. IEEE, 2013
[11] LeCun, Yann, Koray Kavukcuoglu, and Clément Farabet. “Convolutional networks and applications in vision.” In ISCAS, vol. 2010, pp. 253-256. 2010.
[12] Taigman, Yaniv, Ming Yang, Marc′Aurelio Ranzato, and Lior Wolf. “Deepface: Closing the gap to human-level performance in face verification.” In Proceedings of the IEEE conference on computer vision and pattern recognition, pp. 1701-1708. 2014.
[13] Graves, Alex, Abdel-rahman Mohamed, and Geoffrey Hinton. “Speech recognition with deep recurrent neural networks.” In Acoustics, speech and signal processing (icassp), 2013 ieee international conference on, pp. 6645-6649. IEEE, 2013.
[14] Collobert, Ronan, Jason Weston, Léon Bottou, Michael Karlen, Koray Kavukcuoglu, and Pavel Kuksa. “Natural language processing (almost) from scratch.” Journal of Machine Learning Research 12, no. August (2011): 2493-2537.
[15] Jaitly, Navdeep, Patrick Nguyen, Andrew Senior, and Vincent Vanhoucke. “Application of pretrained deep neural networks to large vocabulary speech recognition.” In Thirteenth Annual Conference of the International Speech Communication Association. 2012.
[16] Seymour, Rowan, Darryl Stewart, and Ji Ming. “Comparison of image transform-based features for visual speech recognition in clean and corrupted videos.” Journal on Image and Video Processing 2008 (2008): 14.
[17] Kingsbury, Brian. “Lattice-based optimization of sequence classification criteria for neural-network acoustic modeling.” In Acoustics, Speech and Signal Processing, 2009. ICASSP 2009. IEEE International Conference on, pp. 3761-3764. IEEE, 2009.
[18] Kingsbury, Brian, Tara N. Sainath, and Hagen Soltau. “Scalable minimum Bayes risk training of deep neural network acoustic models using distributed Hessian-free optimization.” In Thirteenth Annual Conference of the International Speech Communication Association. 2012.
[19] Zechner, Klaus, and Alex Waibel. “Minimizing word error rate in textual summaries of spoken language.” In Proceedings of the 1st North American chapter of the Association for Computational Linguistics conference, pp. 186-193. Association for Computational Linguistics, 2000.
[20] Messer, K., J. Matas, J. Kittler, J. Luettin, and G. Maitre. “XM2VTSbd: The extended M2VTS database, proceedings 2nd conference on audio and video-base biometric personal verification (AVBPA99).” (1999).
[21] Luettin, Juergen, and Gilbert Maitre. “Evaluation protocol for the XM2FDB database (Lausanne Protocol).” (1998): 98-05.

### APPENDIX 2—KEY FEATURES

This section summarises the most important high-level features; an implementation of the invention may include one or more of these high-level features, or any combination of any of these. Note that each feature is therefore potentially a stand-alone invention and may be combined with any one or more other feature or features.

### A. ‘Liveness’ Check Using a Viseme Based Machine Learning Model

A liveness detection system comprising:
(i) an interface configured to receive a video stream;
(ii) a word, letter, character or digit generator subsystem configured to generate and output one or more words, letters, characters or digits to an end-user;
(iii) a computer vision subsystem configured to analyse the video stream received, and to determine, using a lip reading or viseme processing subsystem, if the end-user has spoken or mimed the or each word, letter, character or digit, and to output a confidence score that the end-user is a “live” person.

### Optional:

Video stream includes image data such as 2D image data, 3D image data, infrared image sensor data or depth sensor data.
Video stream only includes infrared image sensor data.
The lip reading processing subsystem uses a viseme based machine learning model.
The generator subsystem is configured to generate and output a random word, letter, character or phrase to the end-user.
The random word, letter, character or phrase is selected from a large corpus of data.
The lip reading processing subsystem tracks and extracts the movement of the end-user lip.
Machine learning model is a deep neural network model.
The lip reading processing subsystem processes the video stream and extracts viseme features.
The lip reading processing subsystem implements a feature extraction method, such as DCT (Discrete Cosine Transform), PCA (Principal Component Analysis), LDA (Linear Discriminant Analysis) feature extraction method or a learnt feature extraction method.
Lip reading processing subsystem uses Gaussian Mixture Model (GMM), Hidden Markov Model (HMM), and/or Deep Neural Network techniques.
The lip reading processing subsystem implements an illumination compensation method.
The lip reading processing subsystem implements an automatic illumination compensation algorithm such as an automatic and adaptive contrast limited adaptive histogram equalization (CLAHE) algorithm.
The interface is further configured to receive an audio stream.
Algorithm is used for merging the video and audio stream.
The computer vision subsystem is configured to authenticate the end-user when the confidence score is above a predefined threshold.
The system grants or denies the end-user access to an application running on a connected device.
A confidence scoring algorithm is implemented that compares extracted viseme features, detected speech and the words, letters, characters or digits generated.

### Method for Liveness Detection

A method for liveness detection, the method includes:
(i) receiving a video stream;
(ii) generating and outputting one or more words, letters, characters or digits to an end-user;
(iii) analysing the video stream received, and determining, using a lip reading or viseme processing technique, if the end-user has spoken or mimed the or each word, letter, character or digit, and outputting a confidence score that the end-user is a “live” person.

### B. Authentication

An authentication system for assessing whether a person viewed by a computer-based system is authenticated or not, the system comprising:
(i) an interface configured to receive a video stream;
(ii) a word, letter, character or digit generator subsystem configured to generate and output one or more words, letters, characters or digits to an end-user;
(iii) a computer vision subsystem configured to (a) analyse the video stream received, and to (b) determine, using a lip reading or viseme processing subsystem, if the end-user has spoken or mimed the or each word, letter, character or digit, and to (c) compare the data from the lip reading or viseme processing subsystem with stored data corresponding to the identify claimed by that person; and to (d) output a confidence score that the end-user is the person they claim to be.

An authentication system comprising
(i) an interface configured to receive a video stream;
(ii) a word, letter, character or digit generator subsystem configured to generate and output one or more words, letters, characters or digits to an end-user;
(iii) a computer vision subsystem configured to analyse the video stream received, and to determine, using a lip reading or viseme processing subsystem, if the end-user has spoken or mimed the or each word, letter, character or digit, and to output a confidence score that the end-user is a “live” person.
in which the computer vision subsystem is configured to authenticate the end-user when the confidence score is above a predefined threshold.

### Optional:

Video stream includes image data such as 2D image data, 3D image data, infrared image sensor data or depth sensor data.
Video stream only includes infrared image sensor data.
The computer vision subsystem uses a viseme based machine learning model.
The generator subsystem is configured to generate and output a random word, letter, character or phrase to the end-user.
The random word, letter, character or phrase is selected from a large corpus.
The computer vision subsystem implements an automatic and adaptive contrast limited adaptive histogram equalization (CLAHE) algorithm.
The lip reading processing subsystem processes the video stream and extracts viseme features.
The system grants or denies the end-user access to an application running on a connected device.
A confidence scoring algorithm is implemented that compares the extracted viseme features, the detected speech and the random phrase generated.
   C. Lip Reading with Illumination Compensation

Lip reading system comprising
(i) an interface configured to receive a video stream, and
(ii) a computer vision subsystem configured to analyse the video stream received, using a lip reading or viseme processing subsystem, and to track and extract the movement of an end-user lip, and to recognize a word or sentence based on the lip movement,
   in which the lip reading processing subsystem implements an automatic illumination compensation algorithm.

### Optional:

Video stream includes image data such as 2D image data, 3D image data, infrared image sensor data or depth sensor data.
Video stream only includes infrared image sensor data.
The lip reading processing subsystem analyses each video frame and the parameters of illumination compensation algorithm are adaptively selected for each video frame.
The illumination compensation algorithm is based on Contrast Limited Adaptive Histogram Equalization (CLAHE).
For each video frame, an optimal tile size and clip limit is chosen using the entropy curve method.
The clip limit associated with the maximum point of curvature is selected as the optimal setting.
The illumination compensation algorithm uses a classification model trained with a dataset containing video frames with varying lighting conditions.
The training dataset is augmented using a 3-dimensional gamma-mask that finds an optimal value for each pixel in the video frames.

### D. Speech Rate Detection

Lip reading system for determining an end-user rate of speech comprising:
(iii) an interface configured to receive a video stream, and
(iv) a computer vision subsystem configured to analyse the video stream received, using a lip reading or viseme processing subsystem, and to track and extract the movement of an end-user lip,
   in which the computer vision subsystem determines and outputs the end-user rate of speech based on the analysis of the end-user lip movement.

### Optional:

Video stream includes image data such as 2D image data, 3D image data, infrared image sensor data or depth sensor data.
Video stream only includes infrared image sensor data.
The lip reading processing subsystem uses a viseme based machine learning model.
The lip reading processing subsystem implements an illumination compensation method.
The lip reading processing subsystem processes the video stream and extracts viseme features.
Viseme features are converted into time-stamped syllable sequences using an automatic syllabification process.
The computer vision subsystem determines the end-user syllables per minute rate of speech.
The computer vision subsystem measures the change in duration of the end-user syllables throughout the video stream.
The computer vision subsystem determines or infer an end-user emotional state from an analysis of the rate of speech.
The rate of speech is compared to an historic of known rate of speech for the end-user.
The rate of speech is compared to an historic of standard rate of speech obtained from a large corpus of end-users.
The computer vision subsystem is configured to analyse a video stream including more than one person and to infer the person that is the prominent speaker.
   E. Lip Reading System which Adapts to Pose Variation

Lip reading system comprising
(iii) an interface configured to receive a video stream, and
(iv) a computer vision subsystem configured to analyse the video stream received, using a lip reading or viseme processing subsystem and to track and extract the movement of an end-user lip, and to recognize a word or sentence based on the lip movement,
   in which the lip reading processing subsystem is further configured to dynamically adapt to any variation in head rotation or movement of the end-user.

### Optional:

Video stream includes image data such as 2D image data, 3D image data, infrared image sensor data or depth sensor data.
Video stream only includes infrared image sensor data.
The lip reading processing subsystem processes the video stream and extracts viseme features.
The lip reading processing subsystem uses a viseme based machine learning model.
The lip reading processing subsystem implements an illumination compensation method.
The lip reading processing subsystem uses a viseme based neural network model.
The neural network model includes multiple pose-dependent autoencoders, each trained on a large dataset of video frames corresponding to a specific pose or head rotation of an end-user.

### F. Lip Reading Including Splicing Detection

Lip reading system comprising
(i) an interface configured to receive a video stream, and
(ii) a computer vision subsystem configured to analyse the video stream received, using a lip reading or viseme processing subsystem, to track and extract the movement of an end-user lip, and to recognize a word or sentence based on the lip movement,
   in which the computer vision subsystem is able to detect video splicing attacks using a splicing detection method from the analysis of pixel information across sequential video frames.

### Optional:

Video stream includes image data such as 2D image data, 3D image data, infrared image sensor data or depth sensor data.
Video stream only includes infrared image sensor data.
The lip reading processing subsystem implements an illumination compensation method.
The lip reading processing subsystem processes the video stream and extract viseme features.
The lip reading processing subsystem uses a viseme based machine learning model.
A video splicing attack is detected when the standard deviation of pixel values across sequential frames is higher than a predefined threshold value.
The predefined threshold value is determined through empirical studies.
Splicing detection method is based on a statistical based approach.
Splicing detection method takes into account frame level transition across sequential frames such as velocity and acceleration of the end-user facial features.
Splicing detection method implements a machine learning based method to detect video splicing that analyses pixel information across sequential frames.
The computer vision subsystem outputs a confidence score that a video splicing attack has been detected correctly.
The confidence score also takes into account video frames parameters such as resolution, illumination and lip movement.

### G. A Lipreading System Designed for the Voice Impaired

An automatic lip reading system for a voice impaired end-user comprising:
(i) an interface configured to receive a video stream;
(ii) a computer vision subsystem configured to analyse the video stream received, using a lip reading or viseme processing subsystem, to track and extract the movement of an end-user lip, and to recognize a word or sentence based on the lip movement,
(iii) a software application running on a connected device, configured to receive the recognized word or sentence from the computer vision subsystem and to automatically display the recognized word or sentence.

### Optional

Video stream includes image data such as 2D image data, 3D image data, infrared image sensor data or depth sensor data.
Video stream only includes infrared image sensor data.
The computer vision subsystem uses a viseme based machine learning model.
The computer vision subsystem implements an illumination compensation method.
The computer vision subsystem processes the video stream and extracts viseme features.
The software application provides the interface configured to receive the video stream.
In which a training dataset representing a universal visual speech recognition based model is used to train the machine learning model.
In which a training dataset adapted to a specific end-user is used to train the machine learning model.
In which the training dataset is automatically updated when an end-user operates or interacts with the system, based on the interactions with the system and the recognised word or sentence.
In which the specific end-user is a patient with a tracheotomy.

### H. AVSR System

Audio visual speech recognition system comprising:
(iii) an interface configured to receive a video stream and an audio stream,
(iv) a speech recognition subsystem configured to analyse the audio stream, detect speech from an end-user, and recognise a word or sentence spoken by the end-user,
(v) a computer vision subsystem configured to analyse the video stream received, using a lip reading or viseme processing subsystem, and to track and extract the movement of the end-user lip, and to recognise a word or sentence based on the lip movement,
(vi) a merging subsystem configured to analyse the recognized words or sentences by the speech recognition subsystem and lip reading processing subsystem and to output a list of candidate words or sentences, each associated with a confidence score or rank referring to a likelihood or probability that the candidate word or sentence has been spoken by the end-user.

### Optional:

Video stream includes image data such as 2D image data, 3D image data, infrared image sensor data or depth sensor data.
Video stream only includes infrared image sensor data.
The lip reading processing subsystem implements an illumination compensation method.
The lip reading processing subsystem processes the video stream and extracts viseme features.
The lip reading processing subsystem uses a viseme based machine learning model.
The merging subsystem outputs a candidate word lattice.
The merging subsystem constructs path weights from candidate word statistics.
The merging subsystem identifies a best path of the word lattice.
The list of candidate words or sentences is compared to a set of target words or sentences.
The merging subsystem determines the edit distance between each candidate word or sentence and each target word or sentence.
Edit distance is a word-level edit distance or phonetic-level edit distance.
Each candidate word or sentence is associated with a set of similarity score against each target word or sentence.
The merging subsystem ranks the set of target words or sentences.
The merging subsystem outputs a list with the highest rankings target words or sentences.
The merging subsystem outputs the highest ranking target word or sentence.
The merging subsystem weighs or assesses the confidence scores or ranks based on video stream or audio stream quality.
The merging subsystem weighs or assesses the confidence scores or ranks based on past findings and machine learning model.
Speech or language model is used to update confidence scores, ranks or weights.
Merging subsystem dynamically updates the list of candidate words or sentences and their confidence score as the video and audio streams are being processed.

### Generally Applicable Features and Use Cases:

The computer vision subsystem is deployed locally at a device, such as a smartphone, ATM, car infotainment or dashboard or other device; or within a non-cloud-based server or data centre.
The computer vision subsystem is a cloud-based computer vision subsystem.
The system is optimised for environment with poor lighting condition.
The system is optimised for night time conditions.
When a portion of the end-user lip or mouth is occluded, the system makes use of other facial parameters to infer missing information due to a portion of the lip or mouth being occluded.
The system is an underwater lip reading system.
The system is used for online authentication.
The system is used to approve or authorize an online transaction.
The system is configured for in-vehicle voice activation.
The system is configured for personal assistants (Siri, Cortana, Google Now, Echo).
The system is configured SmartHome voice control.
The system is used for Keyword/phrase recognition in video segment (e.g. surveillance);
The system is configured for improved subtitling for live broadcast.
The system is configured for non-repudiation of on line transactions.
The system is configured for anti spoofing during on line authentication.
The system is configured to detect “words of interest”, key words/phrases in CCTV footage.
The system is configured for securing identity confirmation during social media interactions.
The system is configured for prevention of driving/use of machinery while under the influence of drugs or alcohol.
The system is configured for interaction with machines in industrial environments.
The system is configured to detect anger in public environments or during on line transactions and to send an alert following the anger detection.
The system is configured to detect tiredness and to send an alert to an external or connected device when tiredness has been detected.
The system is configured for real time subtitling of media.
The system is configured for assisting hear-impaired with conversations (e.g. google glasses app which gives real time transcription of speech from whomever the glasses are pointed at).
The system is configured for recreation of degraded speech in noisy environments.
The system is configured for stroke detection.
The system is configured for speech training or therapy.
Speech training or therapy is tailored for a certain category of end-users, such as children or second-language end-users or end-users that have suffered a stroke.
The system is configured for multi-language end-users.
The system is configured for lie detection.
The system is configured for enhanced interactive voice recognition system.
The system operates in real time.
A smartphone, tablet, laptop, desktop, in-vehicle dashboard implementing the system above.

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1-63. (canceled)

63. An automatic lip reading system for an end-user comprising:
(i) an interface configured to receive a video stream;
(ii) a computer vision subsystem configured to analyse the video stream received, using a lip reading or viseme processing subsystem, to track and extract the movement of an end-user lip, and to recognize a word or sentence based on the lip movement;
(iii) a software application running on a connected device, configured to receive the recognized word or sentence from the computer vision subsystem and to automatically output the recognized word or sentence.

64. The system of claim 63, in which the video stream includes image data such as 2D image data, 3D image data, infrared image sensor data or depth sensor data.

65. The system of claim 63, in which the video stream only includes infrared image sensor data.

66. The system of claim 63, in which the computer vision subsystem uses a viseme based machine learning model.

67. The system of claim 63, in which the computer vision subsystem implements an illumination compensation algorithm.

68. The system of claim 63, in which the computer vision subsystem processes the video stream and extracts viseme features.

69. The system of claim 63, in which the software application provides the interface configured to receive the video stream.

70. The system of claim 63, in which a training dataset representing a universal visual speech recognition based model is used to train the machine learning model.

71. The system of claim 63, in which a training dataset adapted to a specific end-user is used to train the machine learning model.

72. The system of claim 63, in which the training dataset is automatically updated when an end-user operates or interacts with the system.

73. The system of claim 63, in which the end-user is a voice impaired user, such as a patient with a tracheotomy.

74-95. (canceled)

96. The system of claim 63, which is optimized for environment with poor lighting condition.

97-125. (canceled)

126. A method of optimising a lip reading system for an end-user comprising:
(i) receiving a video stream at an interface configured to receive a video stream;
(ii) at a lip reading processing subsystem configured to analyse the video stream, the steps of analysing the video stream and tracking and extracting the movement of an end-user lip, and recognizing a word or sentence based on the lip movement;
(iii) at a software application running on a connected device, the steps of receiving the recognized word or sentence from the lip reading processing subsystem, and automatically outputting the recognised word or sentence.

127. (canceled)

128. The system of claim 63, in which the computer vision subsystem is configured to output a list of recognized words or sentences based on the lip movement of the end-user, each recognized word or sentence associated with a likelihood or probability that the recognized word or sentence has been spoken or mimed by the end-user.

129. The system of claim 63, in which the software application is configured to display or provide an audio output of the recognized word or sentence.

130. The system of claim 67, in which the lip reading processing subsystem analyses each video frame and the parameters of illumination compensation algorithm are adaptively selected for each video frame.

131. The system of claim 67, in which the illumination compensation algorithm is based on Contrast Limited Adaptive Histogram Equalization (CLAHE).

132. The system of claim 67, in which for each video frame, an optimal tile size and clip limit is chosen using an entropy curve based method.

133. The system of claim 132, in which the clip limit associated with the maximum point of curvature is selected as an optimal setting.

134. The system of claim 67, in which the illumination compensation algorithm uses a classification model trained with a dataset containing video frames with varying lighting conditions.

135. The system of claim 134, in which the training dataset is augmented using a 3-dimensional gamma-mask that finds an optimal value for each pixel of the video frames.

136. The system of claim 63, in which the lip reading processing subsystem is further configured to dynamically adapt to any variation in head rotation or movement of the end-user.

137. The system of claim 63, in which the computer vision subsystem uses a viseme based machine learning model, in which a neural network model includes multiple pose-dependent autoencoders, each trained on a large dataset of video frames corresponding to a specific pose or head rotation of an end-user.

138. The system of claim 63, in which the computer vision subsystem determines and outputs the end-user rate of speech based on the analysis of the end-user lip movement.
